(19) United States
(12) Patent Application Publication
(10) Pub. No.: US 2012/0274499 A1
(43) Pub. Date: Nov. 1, 2012

(54) Radar imaging via spatial spectrum measurement and MIMO waveforms

(75) Inventor: Donald C. D. Chang, Thousand Oaks, CA (US)

(73) Assignee: SPATIAL DIGITAL SYSTEMS, Chatsworth, CA (US)

(21) Appl. No.: 13/098,351

(22) Filed: Apr. 29, 2011

(51) Int. Cl. G01S 13/06

(52) U.S. Cl. 342/107; 342/385; 342/368

(57) ABSTRACT

The proposed MIMO radar imaging method takes advantages of measurement techniques of spatial frequency components of an RF area image from radar returns. To minimize size, weight and power (SW&P), minimum redundancy arrays (MRAs) for both Tx and Rx with unique geometries are proposed. MIMO waveforms are utilized to index the radiated illuminations to a targeted area in the forms of 1-D spatial frequency components. Consequently, the corresponding radar returns from the targeted field of view (FOV) are captured by the Rx MRA. With the knowledge of uniquely designed MRA array geometries, virtual beams are synthesized in Rx processor; usually one Tx and many contiguous Rx fan beams. These virtual beams may be dynamically “moved” to different beam positions. The elongated beam direction for Tx fan beam and that for Rx fan beams are perpendicular to one another. Thus intersections of the Tx fan-beam and many Rx fan-beams are the very areas of radar returns. We refer those areas as virtual beam crosses. Conventional range and Doppler gating processing shall then be applied to the beam crosses concurrently. Radar return pixel-by-pixel within various beam crosses are measured individually. Radar images can then be synthesized.

MIMO radars via spatial spectrum measurements are well suited for wide angle surveillance via improved angle estimation and minimum detectable velocity. SDS proposed MIMO radar design concepts on moving platforms can be used for both the line-of sight (LOS) SAR/GMTI applications. For fixed Radar, they are applicable for fixed radars LOS target detection and tracking, or imaging. They may also be useful for OTH maritime target detection and tracking utilizing evaporation duct propagation

### RELATED APPLICATION DATA

This application, pursuant to 35 U.S.C. §119(e), is a continuation of U.S. Pat. No. 7,609,198 issued on Oct. 27, 2009

### BACKGROUND OF THE INVENTION

1. Field of the Invention

The application of MIMO techniques [2, 3, 4, and 5] to radar offers many potential advantages, including improved resolution and sensitivity. However, there is no one clear definition of what MIMO radar is. It is common to assume that independent signals are transmitted through different antenna elements, and that these signals, after propagating through the environment and reflected by targeted areas, will be received by multiple antenna elements. The invention is about using multiple MIMO waveforms to index radiated fields either from individual elements or combinations of elements which form geometries to measure various spatial frequency components of radar images. The corresponding radar returns from a targeted field of view (FOV) due to the illuminations from different MIMO waveforms can be separated and post-processed accordingly. The post-processing is programmed to generate effects as if the processed radar returns are from various targeted areas illuminated by dynamic transmitting beams within the FOV. The invention is about the generations of virtual transmit beams in the post-processing of radar receivers

2. Description of Related Art

The present invention relates to MIMO radar via measurement of spatial spectrum [1] with capability of to virtually refocus Tx power in a Rx process. MIMO waveforms are used to index either radiations of various spatial frequency components or element illuminations by a transmit array over the FOV of interest. Post processing on a radar receiver will separate the associated radar returns from these illuminations. With uniquely designed antenna array geometries, virtual beams are synthesized; usually one Tx and many contiguous Rx fan beams. These virtual beams may be dynamically “moved” to different beam positions in Rx processor.

Depending upon the MIMO radar's mode of operation, the array design, and the environment, the advantages of MIMO radars may be significant. In general, there are two advantages to MIMO radar compared to traditional radar [2]. The first advantage is diversity. Given differences in viewing angles on a particular target, the diversity in the scattering response of the target can provide significant improvements in detection probability.

The second advantage is resolution improvement. After coherent processing of multiple simultaneous waveforms at multiple receivers, a response matrix as a function of delay (and possibly Doppler frequency) can be estimated. There are a variety of ways to interpret this response. One way reforms the response matrix so that it appears to be the response of a virtual MIMO receive array. Under the appropriate conditions, the geometry of this virtual array is equivalent to an array formed by the convolution of the transmit array geometry and the receive array geometry.

### SUMMARY OF THE INVENTION

The proposed MIMO radar imaging method takes advantages of measurement techniques of illuminations of spatial frequency components or those from individual elements of an area image from radar returns. To minimize size, weight and power (SW&P), minimum redundancy arrays (MRAs) [6, 7] for both transmit (Tx) and receiving (Rx) with unique geometries are proposed. MIMO waveforms are utilized to index the radiated illuminations to a targeted area in the forms of 1-D spatial frequency components.

Consequently, the corresponding radar returns from the targeted field of view (FOV) are captured by the Rx MRA. With the knowledge of uniquely designed MRA array geometries, virtual beams are synthesized in Rx processor; usually one Tx and many contiguous Rx fan beams. These virtual beams may be dynamically “moved” to different beam positions. The elongated beam direction for Tx fan beam and that for Rx fan beams are perpendicular to one another. Thus intersections of the Tx fan-beam and many Rx fan-beams are the very areas of “focused” radar returns. We refer those areas as virtual beam crosses. Conventional range and Doppler gating process shall then be applied to the beam crosses concurrently, quantitatively measuring Radar return pixel-by-pixel within various beam crosses individually. Radar images can then be synthesized.

Our design principle is to utilize the measurements of spatial frequency components (or spatial spectrum) of a radar image, enhancing its resolution by taking advantage of different geometries of Tx and Rx arrays. We use side-looking radar as a design example. Nadir looking Radar can also be configured to take advantage of the spatial spectrum concepts in their imaging and detection functions.

In addition, we will use co-located Mills Cross [8], instead of monostatic radar geometry for illustration. The Tx array shall illuminate a FOV with spatial spectrum pattern in one direction, say the cross-track, or α, direction, while the Rx array receiving the spatial spectrum measurements of the radar return over the same FOV on the perpendicular direction, the along-track direction. The illuminations may also be from individual elements. The illuminations are indexed by orthogonal MIMO waveforms.

The proposed architectures are applicable to radars on mobile platforms. For airborne or space-borne platforms, they can be configured to do SAR and GMTI missions similar to those in the literatures [9,10, and 11].

### BRIEF DESCRIPTION OF THE DRAWINGS

FIG. 1 depicts simplified block diagram of a linear array for Radar applications with 7 elements with A spacing between adjacent elements. The array performs both transmission and reception beam forming functions via a digital beam forming (DBF)

FIG. 2a illustrates simulated I-components of the spatial spectrum from the 7-element linear array in FIG. 1. The units in vertical axis are linear in “voltage”. There are 7 spatial frequency components; (1) dc, (2) u/2, (3) 2(u/2), (4) 3(u/2), (5) 4(u/2), (6) 5(u/2), and (7) 6(u/2). The unit “u” is dimensionless and equals to sin θ. The sum of these 7 spatial frequency components, Isum, peaks up at θ=0°.

FIG. 2b illustrates simulated Q-components of the spatial spectrum from the 7-element linear array in FIG. 1. The units in vertical axis are linear in “voltage.” There are 6 spatial frequency components; (1) u/2, (2) 2(u/2), (3) 3(u/2), (4) 4(u/2), (5) 5(u/2), and (6) 6(u/2). The Q component for the dc is defined as a constant, and chosen as zeros. The unit “u” is dimensionless and equals to sin θ. The sum of these 6 Q-components of spatial frequencies, Qsum, equals to zero up at θ=0°.

FIG. 2c illustrates simulated I-sum, Q-sum, and total-sum of the spatial spectrum from the 7-element linear array in FIG. 1. The units in vertical axis are linear in “voltage.”

FIG. 2d illustrates a simulated total-sum of the spatial spectrum from the 7-element linear array in FIG. 1. The units in vertical axis are in “dB.” It is clear the beam is pointed at θ=0°, the peak gain is in relative scale and is not normalized.

FIG. 3a illustrates simulated I-components of the spatial spectrum from the 7-element linear array in FIG. 1. The units in vertical axis are linear in “voltage”. There are 7 spatial frequency components; (1) dc, (2) u/2, (3) 2(u/2), (4) 3(u/2), (5) 4(u/2), (6) 5(u/2), and (7) 6(u/2). The unit “u” is dimensionless and equals to sin θ. The sum of these 7 spatial frequency components, Isum, peaks up at θ=10°.

FIG. 3b illustrates simulated Q-components of the spatial spectrum from the 7-element linear array in FIG. 1. The units in vertical axis are linear in “voltage.” There are 6 spatial frequency components; (1) u/2, (2) 2(u/2), (3) 3(u/2), (4) 4(u/2), (5) 5(u/2), and (6) 6(u/2). The Q component for the dc is defined as a constant, and chosen as zeros. The unit “u” is dimensionless and equals to sin θ. The sum of these 6 Q-components of spatial frequencies, Qsum, equals to zero up at θ=10°.

FIG. 3c illustrates simulated Isum, Qsum, and total-sum of the spatial spectrum from the 7-element linear array in FIG. 1. The units in vertical axis are linear in “voltage.”

FIG. 3d illustrates a simulated total-sum of the spatial spectrum from the 7-element linear array in FIG. 1. The units in vertical axis are in “dB.” It is clear the beam is pointed at θ=10°, the peak gain is in relative scale and is not normalized.

FIG. 4 illustrates 4 linear array geometries; (1) a 7 element full array, (2) a minimum redundancy array (MRA); the 4 element MRA with same resolution as that of a 7 element full array, (3) an interferometer for measuring low spatial frequency component, and (4) an interferometer for measuring high spatial frequency component.

FIG. 5 consists of two panels; panels A and B depicting, interferometer geometries for measuring, respectively, low and high spatial frequency components, using orthogonal waveforms.

FIG. 6 depicts the 13 I/Q spatial frequency components of a 4 element MRA excited by 13 orthogonal waveforms in accordance with the present invention.

FIG. 7 depicts a line-of-sight (LOS) MIMO radar with a 7-element full aperture linear array for transmit in α-direction and a 4-element MRA as receive in p-direction. The radar is excited by 7 orthogonal waveforms in transmit, and its Rx processing in spatial frequency domain.

FIG. 8 depicts the beam patterns form the Radar in FIG. 7; the 7 (completely overlapped) transmitted circular beam patterns from 7 individual elements in the α-direction, and beam positions of 7 contiguous receiving fan beams in β-direction.

FIG. 9 depicts another line-of-sight (LOS) MIMO radar with a 4-element linear MRA array for transmit in α-direction and a 4-element MRA as receive in β-direction. The radar is excited by 13 orthogonal waveforms in transmit, and its Rx processing in spatial frequency domain.

FIG. 10 depicts an line-of-sight (LOS) MIMO radar on a moving platforms with a 4-element linear MRA array for transmit in cross track-direction and a 4-subarray MRA as receive in the along track-direction. The radar is excited by 13 orthogonal waveforms in transmit, and its Rx processing in spatial frequency domain. Each of the Rx subarrays feature 16 elements on a 4×4 square lattice geometry.

FIG. 11; Rx processing 1 along-track “beam forming” processing for a mobile radar depicted in FIG. 10

FIG. 12; Rx processing 2 cross track beam forming, range gating and Doppler processing and

### REFERENCES

1. U.S. Pat. No. 7,609,198; “Apparatus and method for radar imaging by measuring spatial frequency components,” by D. Chang, issued on Oct. 27, 2009.
2. R. Sabry, G. W. Geling; “A New Approach for Radar/SAR target Detection and Imagery Based on MIMO System Concept and Adaptive Space-Time Coding,” Defence R&D Canada—Ottawa Technical Memorandum; DRDC Ottawa TM 2007-087, May 2007.
3. K. W. Forsythe, D. W. Bliss; “Waveform Correlation and Optimization Issues for MIMO Radar,” in Proc. 39th Asilomar Conf. Signals, Systems, and Computers, November 2005, pp. 1306-1310.
4. K. W. Forsythe, D. W. Bliss, and G. Fawcett, “Multiple-input multiple-output (MIMO) radar: Performance issues,” in Proc. 38th Asilomar Conf. Signals, Syst. Comput., Pacific Grove, Calif., November 2004, vol. 1, pp. 310-315.
5. Y. Jin, Jose M. F. Moura, and N. O'Donoughue; “Time Reversal in Multiple-Input Multiple-Output Radar,” IEEE Journal of Selected Topics In Signal Processing, Vol. 4, No. 1, February 2010.
6. L. Kopilovich; “Minimization of the number of elements in large radio interferometers,” Monthly Notices of the Royal Astronomical Society, Volume 274, Issue 2, pp. 544-546. (MNRAS Homepage), 05/1995.
7. J. Dong; Q. Li; R. Jin; Y. Zhu; Q. Huang; L. Gui; “A Method for Seeking Low-Redundancy Large Linear Arrays in Aperture Synthesis Microwave Radiometers,” IEEE Trans. on Antennas and Propagation, vol. 58, issue 6, 2010.
8. Mills cross (radio telescope), type of radio telescope based on the interferometer, first demonstrated in the 1950s by the Australian astronomer Bernard Yarnton Mills. It consists of interferometers erected in two straight rows intersecting at right angles; www.britannica.com/EBchecked/topic/383009/Mills-cross.
9. “Knowledge-Aided Multichannel Adaptive SAR/GMTI Processing: Algorithm and Experimental Results.” By DiWu, Daiyin Zhu, and Zhaoda Zhu, EURASIP Journal on Advances in Signal Processing, Volume 2010, Article ID 164187, 12 pages.
10. “Development of a GMTI processing system for the extraction of traffic information from TerraSAR-X data,” by S Suchandt, M Eineder, R Müller, A Laika . . . —EUSAR 2006, Proceedings of EUSAR 2006 Conference, VDE Verlag, 6th European Conference on Synthetic Aperture Radar, Dresden (Germany), 2006-05-16-2006-05-18, ISBN 978-3-8007-2960-92006.
11. “Performance Analysis and Comparison for Distributed Space-borne Single-Baseline SAR-ATI/DPCA,” by CA Bin, LAI Chao, ZHANG Yong-Sheng, DU Xiang-Yu; Signal Processing 2010, 26(2) 291-297 DOI:ISSN: 1003-0530 CN: 11-2406/TN

### DETAILED DESCRIPTION OF THE PREFERRED EMBODIMENT

The invention provides smart antenna architectures featuring a transmitting (Tx) feed array for Radar applications using orthogonal waveforms to index RF illumination patterns so that the radar returns from these illuminations are separable in post processors. In stead of transmitting real steerable beams from the feed array, different waveforms are injected to various array feeds. Virtual transmit beams can be constructed via “coherently” combining these indexed radar returns in the post process as if the combined radar returns are from virtual beams focused to various areas of interest within the illumination field of views of the array feeds.

The indexed illuminations may be injected through individual elements or spatial frequency components of the Tx arrays.

In the detailed description that follows, like element numerals are used to indicate like elements appearing in one or more of the figures.

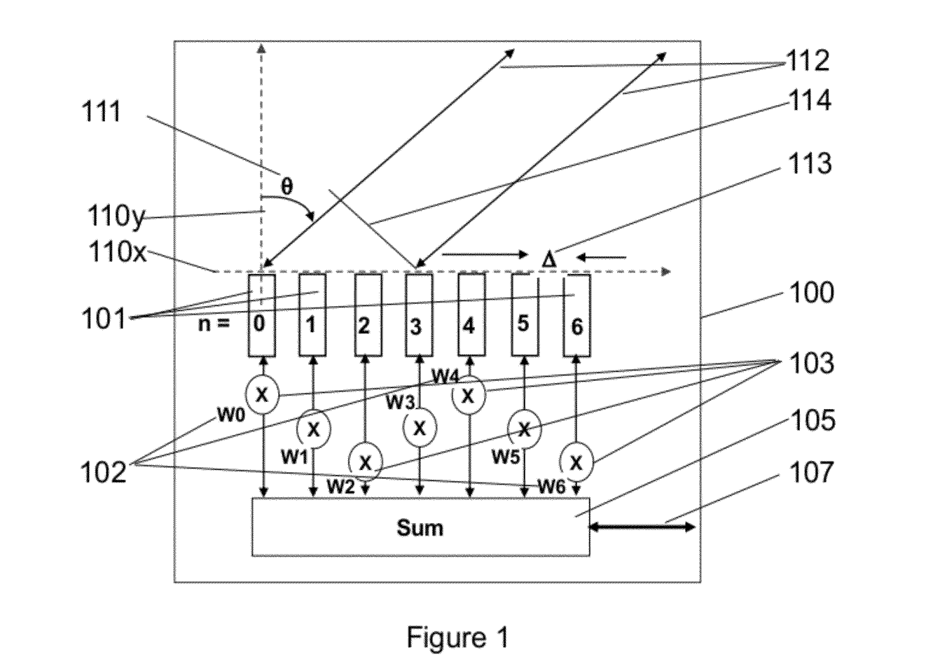

FIGS. 1 (100) depicts a simplified block diagram of a linear array for Radar applications. There are 7 elements (101) equally spaced by Δ (113) between adjacent elements along x-axis (110x). The y-axis (110y) is pointed at the boresight in far field. The array performs both transmission and reception beam forming functions via a digital beam forming (DBF) network;

In Rx modes, an incoming plane wave (112) for a signal stream coming from a direction A° away the array boresight will arrive at various elements in slightly different time slots. The wavefront (114) arriving at element 3 at t=0 will arrive at element 0 at t=3 Δ sin 0/c=3*δT. Similarly the wavefront will appear at element 1 at t=2*δT, element 2 at t=δT. It shall have arrived at elements 4, 5, and 6 at t=−δT, −2*δT, and −3*δT, respectively.

The digital beam forming (DBF) network will compensate for the time or phase delays by a beam weight vector which consists of 7 components [w0, w1, w2, w3, w4, w5, w6] (102) so that the weighted signals becoming in phase at the summing device (105). The beam output (107) will be coherent sums of the seven captured signals. Conversely, the DBF can also provide a BWV such that the weighted sum from the 7 elements for signals coming front the θ° direction becomes zero. A null is formed at the θ° direction.

In Tx modes, the beam input (107) will be divided or duplicated into seven signals channels. The Tx digital beam forming (DBF) network will preprocess the signals to be transmitted compensating by complex multipliers (103) for the time or phase delays by a beam weight vector which consists of 7 components [w0, w1, w2, w3, w4, w5, w6] (102) so that the weighted signals becoming in phase at the wavefront (114) at the direction θ° away front the boresight. As a result, an outgoing plane wave (112) for a signal stream designated for a direction θ° away the array boresight will be radiated from various elements in slightly different time slots. The wavefront (114) injected at element 3 at t=0 will be injected at element 0 at t=−3 Δ sin 0/c=−3*T. Similarly the injected wavefront will appear at element 1 at t=−2*δT, element 2 at t=−δT. It shall also appear at elements 4, 5, and 6 at t=δT, 2*δT, and 3*δT, respectively. Conversely, the Tx DBF can also provide a BWV such that the weighted injection signals in far field from the 7 elements become destructively interfered with one another in the θ° direction. A null is formed at the θ° direction.

For an on-axis beam

g(θ)=ΣWn*exp(j2πnλ/Δ sin(θ));for n=0,1, . . . ,6 (1)

and

g(θ)=gr(θ)+j gq(θ)

Equation (1) is an expression for antenna gain of a 7-element linear array with element spacing, Δ, and can be viewed as weighted sum of 7 spatial frequency components.

The 7 spatial frequencies are: {0, λ/Δ, 2λ/Δ, 3λ/Δ, 4λ/Δ, 5λ/Δ, 6λ/Δ}. The weighting, {Wn}, controls both amplitude tapering and phase progressions on the aperture.

When Wn=1, there are no amplitude tapers on the aperture, and the beam is pointed on the boresite. The real part of the array gain can be written as

gr(θ)=Σ cos(2πnλ/Δ sin(θ));for n=0,1, . . . ,6 (2a)

and the imaginary part of the array gain

gq(θ)=sin(2πnλ/Δ sin(θ));for n=0,1, . . . ,6 (2b)

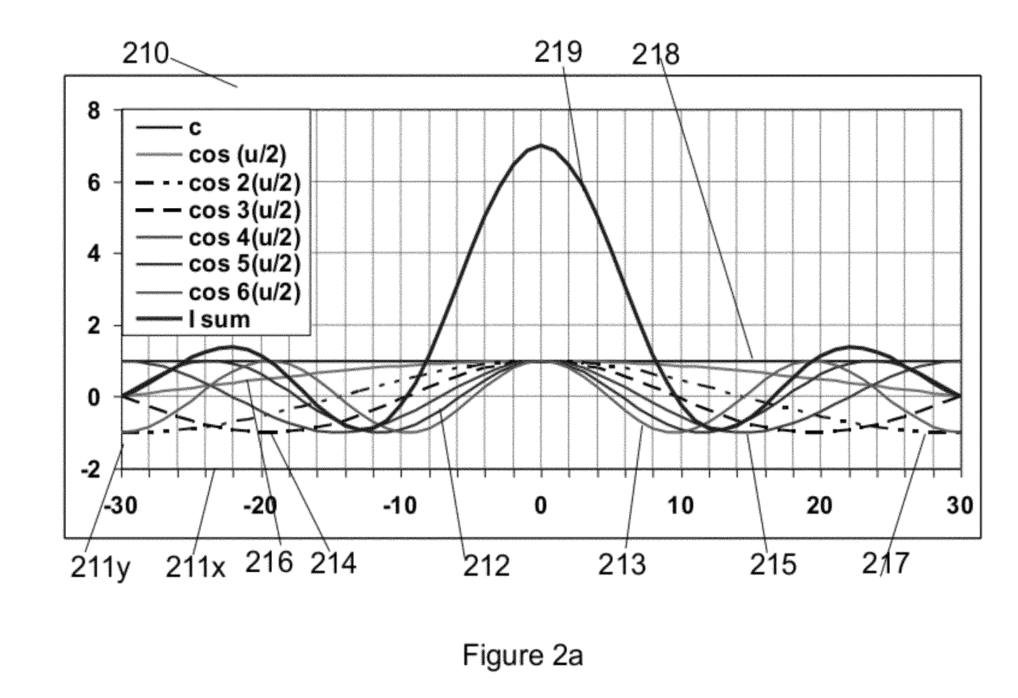

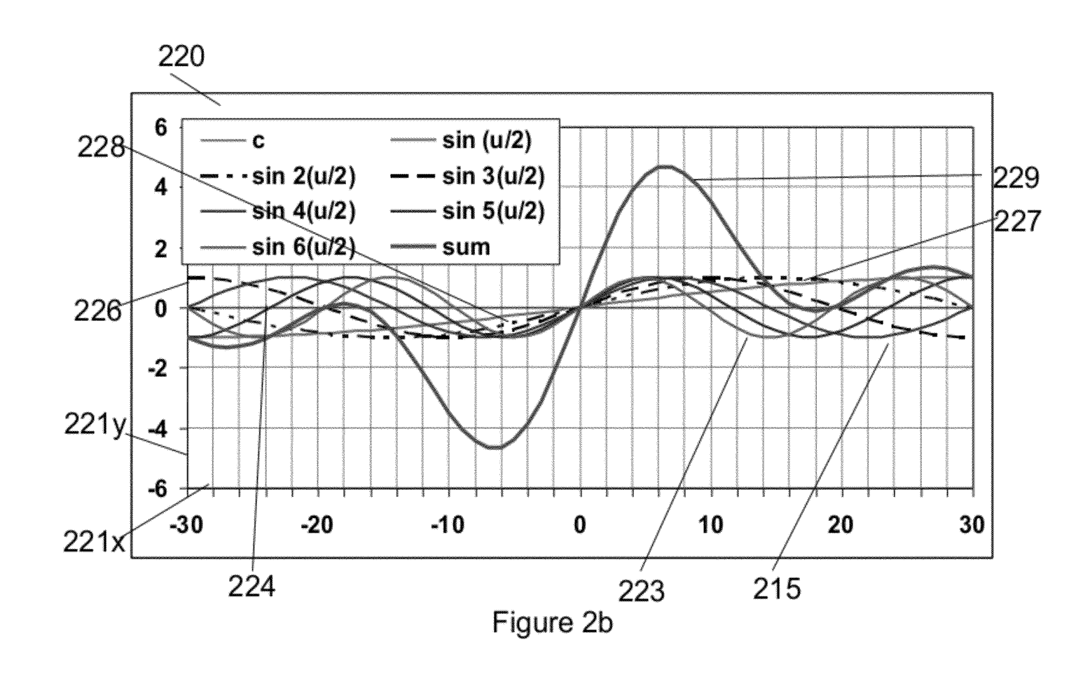

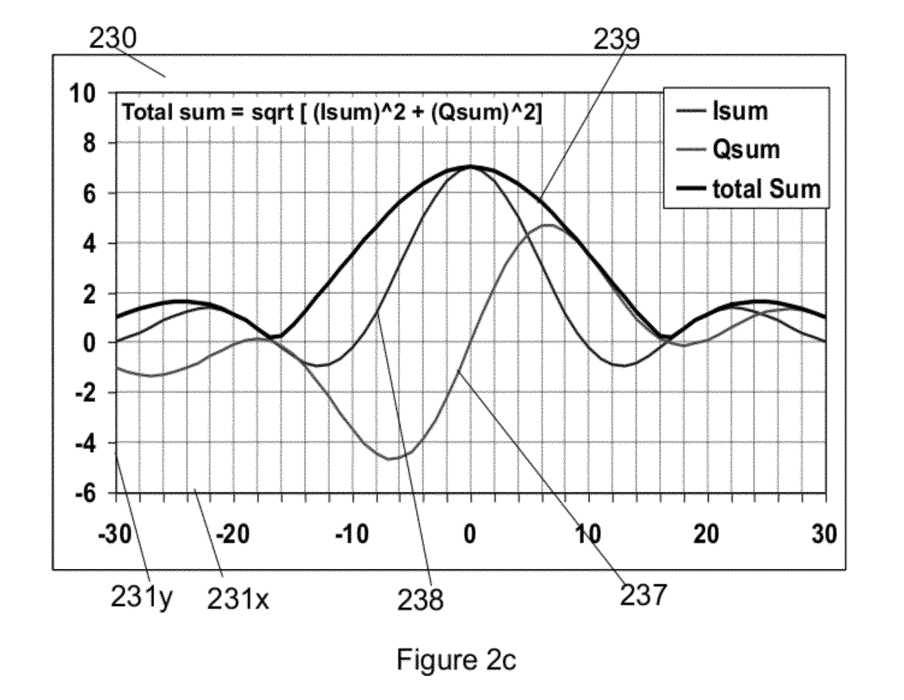

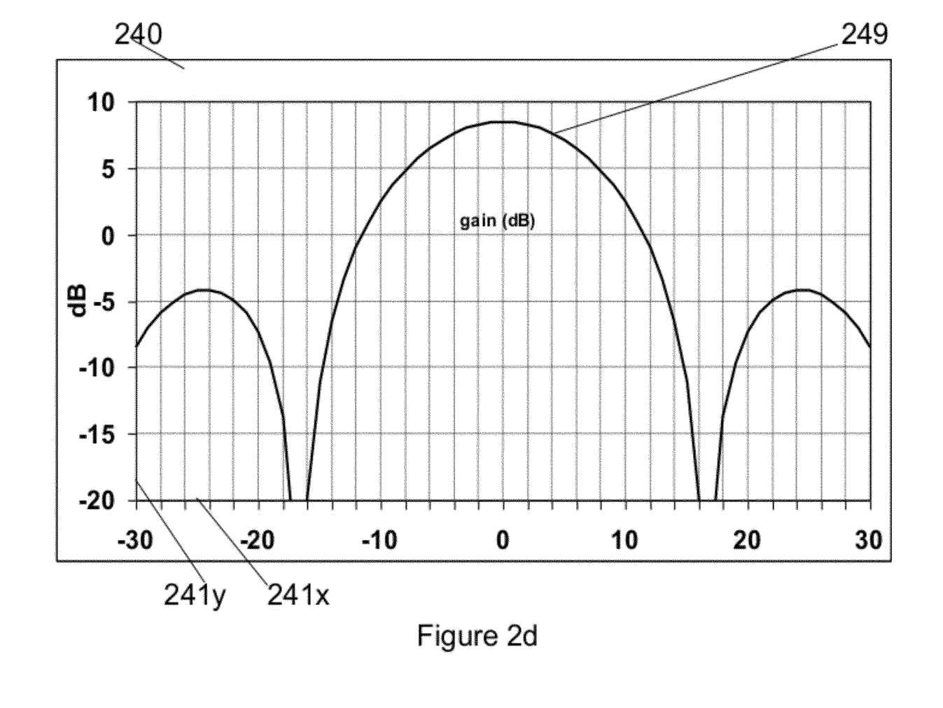

FIG. 2a (210) depicts 1-components of the spatial spectrum associated with the transmit array when the beam is illuminating the boresite. The horizontal axis (211x) indicates the far field angle θ in degrees, and the vertical axis (211y) a linear voltage scale. There are 7 spatial frequencies associated with the 7 element array. The 7 in-phase components, or 1-components, of the spatial spectrum are indicated as cos(θ) (218), cos(u/2) (217), cos 2(u/2) (216), cos 3(u/2) (215), cos 4(u/2) (214), cos 5(u/2)(213), and cos 6(u/2) (212); where u=sin θ. We have assumed that (Δ/λ)=0.5. Δ (113) is the element spacing and 2 is the wavelength associated with the operational frequency. I-sum(219) is the summations of all 7 I-components. At boresight, θ=0°, I-sum equals to “7”, the maximum value, assuming every element contributes one unit of voltage in the far field.

FIG. 2b (220) depicts Q-components of the spatial spectrum associated with the transmit array when the beam is illuminating the boresite. The horizontal axis (221x) indicates the far field angle θ in degrees, and the vertical axis (221y) a linear voltage scale. There are 7 spatial frequencies associated with the 7 element array. The 6 quadrature-phase components, or Q-components, of the spatial spectrum are indicated as sin(u/2) (227), sin 2(u/2) (226), sin 3(u/2) (225), sin 4(u/2) (224), sin 5(u/2) (223), and sin 6(u/2) (222); where u=sin θ. We have assumed that (Δ/λ)=0.5. Δ (113) is the element spacing and λ is the wavelength associated with the operational frequency. Q-sum(219) is the summations of all 6 Q-components. At boresight, θ=0°, Q-sum equals to zero, assuming every element contributes one unit of voltage in the far field.

FIG. 2c (230) depicts I-sum, Q-sum and total sum of the spatial spectrum for the 7 element linear array (101) illuminating the beam position at boresight. The horizontal axis (231x) indicates the far field angle θ in degrees, and the vertical axis (231y) a linear voltage scale. There are 7 spatial frequencies associated with the 7 element array. I-sum (238) is the sum of 7 I-components and Q-sum (237) the sum of 6 Q-components. Total sum (239) is the square root of the sum of I-sum“2 and Q-sum”2.

FIG. 2d (240) depicts the far field antenna gain (249) derived from the total sum (239) of the spatial spectrum for the 7 element linear array (101) illuminating the beam position at boresight. Gain, G(θ), equals to 10*log 10[(total sum̂2)/7] dB. The horizontal axis (241x) indicates the far field angle θ in degrees, and the vertical axis (241y) a logarithmic scale in dB.

For an off axis beam at θ=10°, we shall start with the same equation;

g(θ)=ΣWn*exp(j2πnλ/Δ sin(θ));for n=0,1, . . . ,6 (3)

and

g(θ)=gr(θ)+j gq(θ)

Equation (3) is an expression for antenna gain of a 7-element linear array with element spacing A, and can be viewed as weighted sum of 7 spatial frequency components. The 7 spatial frequencies are: {0, λ/Δ, 2λ/Δ, 3λ/Δ, 4λ/Δ, 5λ/Δ, 6λ/Δ.}

When beam scanned off from boresite, Wn=exp(−jΦn) assuming no amplitude tapers on the aperture. The real part of the array gain can be written as

gr(θ)=Σ cos(2πnλ/Δ sin(θ)−Φn);for n=0,1, . . . ,6 (4a)

and Φn is the “spatial phase” for the nth spatial frequency. Similarly the imaginary part of the array gain

gq(θ)=Σ sin(2πnλ/Δ sin(θ)−Φn);for n=0,1, . . . ,6 (4b)

Furthermore, frequency components with a phase shift Φn can be expended as summation of I and Q components;

cos(2πnλ/Δ sin(θ)−Φn)=cos(2πnλ/Δ sin(θ))*cos(Φn)+sin(2πnλ/Δ sin(θ))*sin(Φn), (4c)

and

sin(2πnλ/Δ sin(θ)−Φn)=sin(2πnλ/Δ sin(θ))*cos(Φn)+cos(2πnλ/Δ sin(θ))*sin(Φn) (4d)

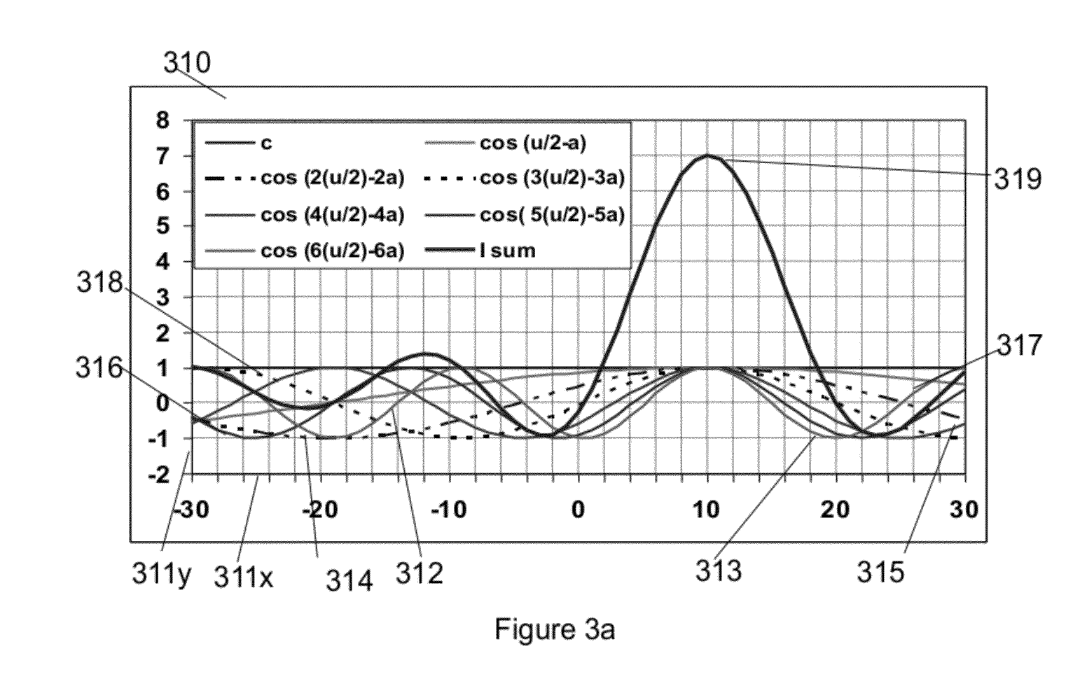

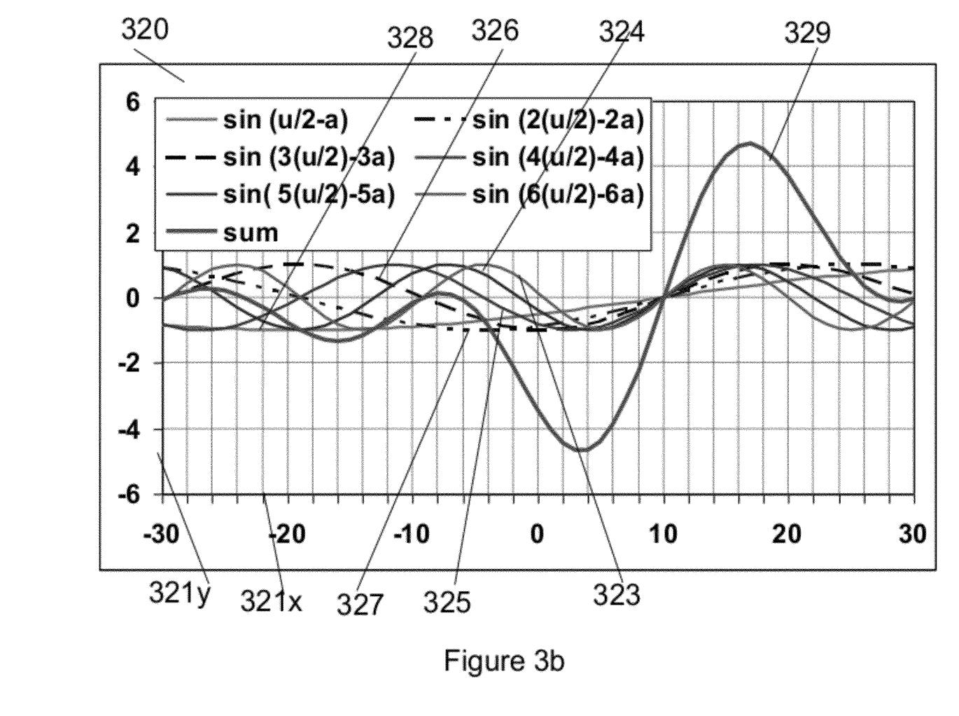

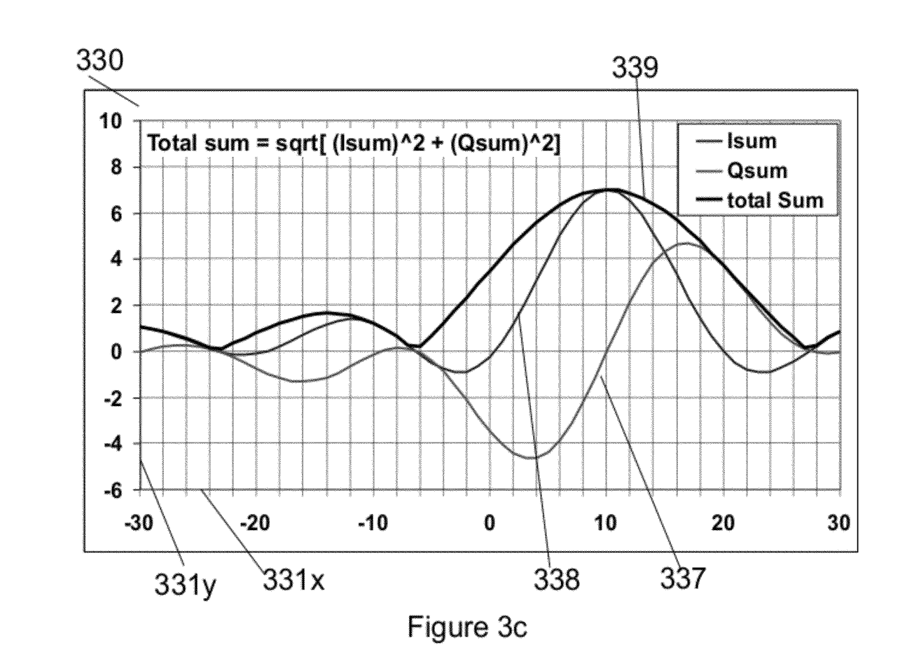

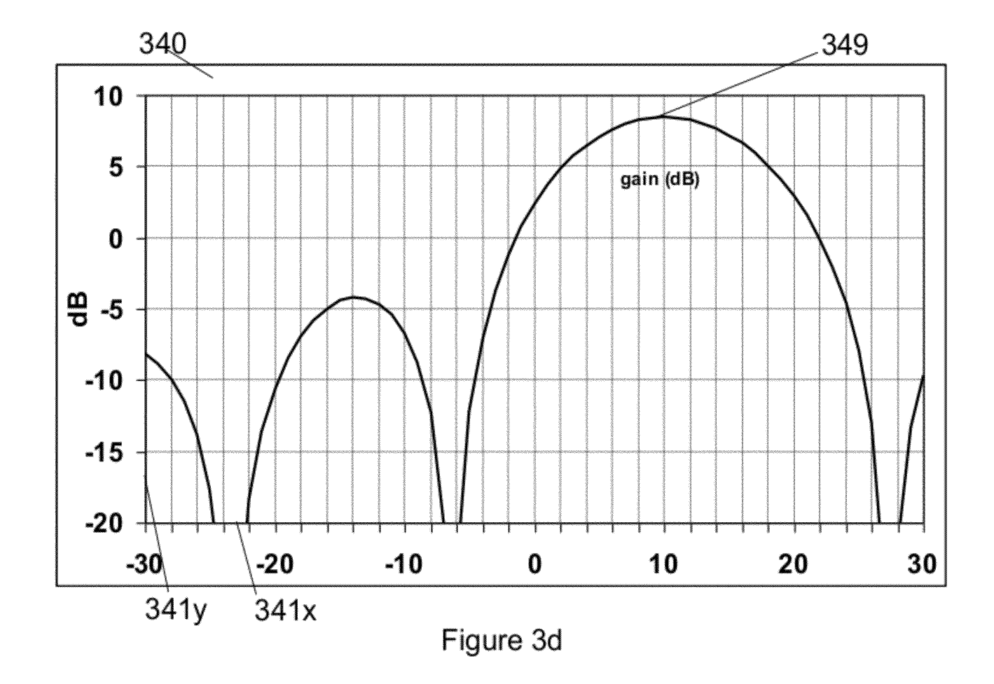

FIG. 3a (310) depicts I-components of the spatial spectrum associated with the transmit array when the beam is illuminating the beam position at θ=10°. The horizontal axis (311x) indicates the far field angle θ in degrees, and the vertical axis (311y) a linear voltage scale. There are 7 spatial frequencies associated with the 7 element array. The 7 in-phase components, or I-components, of the spatial spectrum are indicated as cos(θ) (318), cos(u/2-a) (317), cos 2(u/2-a) (316), cos 3(u/2-a) (315), cos 4(u/2-a) (314), cos 5(u/2-a) (313), and cos 6(u/2-a) (312); where u=sin θ and a=2 sin 10°. We have assumed that (Δ/λ)=0.5. Δ (113) is the element spacing and λ is the wavelength associated with the operational frequency. I-sum (319) is the summations of all 7 I-components. At the beam position where θ=10°, I-sum equals to “7”, the maximum value, assuming every element contributes one unit of voltage in the far field.

FIG. 3b (320) depicts Q-components of the spatial spectrum associated with the transmit array when the beam is illuminating the beam position at θ=10°. The horizontal axis (321x) indicates the far field angle θ in degrees, and the vertical axis (321y) a linear voltage scale. There are 7 spatial frequencies associated with the 7 element array. The 6 quadrature-phase components, or Q-components, of the spatial spectrum are indicated as sin(u/2-a) (327), sin 2(u/2-a) (326), sin 3(u/2-a) (325), sin 4(u/2-a) (324), sin 5(u/2-a) (223), and sin 6(u/2-a) (222); where u=sin θ and a=2 sin 10°. We have assumed that (Δ/λ)=0.5. Δ (113) is the element spacing and is the wavelength associated with the operational frequency. Q-sum (319) is the summations of all 6 Q-components. At the beam position of θ=10°, Q-sum equals to zero, assuming every element contributes one unit of voltage in the far field.

FIG. 3c (330) depicts I-sum, Q-sum and total sum of the spatial spectrum for the 7 element linear array (101) illuminating the beam position at θ=10°. The horizontal axis (331x) indicates the far field angle θ in degrees, and the vertical axis (331y) a linear voltage scale. There are 7 spatial frequencies associated with the 7 element array. I-sum (338) is the sum of 7 I-components and Q-sum (337) the sum of 6 Q-components. Total sum (339) is the square root of the sum of I-sum“2 and Q-sum”2.

FIG. 3d (340) depicts the far field antenna gain (349) derived from the total sum (339) of the spatial spectrum for the 7 element linear array (101) illuminating the beam position at θ=10°. Gain, G(θ), equals to 10*log 10[(total sum̂2)/7] dB. The horizontal axis (341x) indicates the far field angle θ in degrees, and the vertical axis (341y) a logarithmic scale in dB.

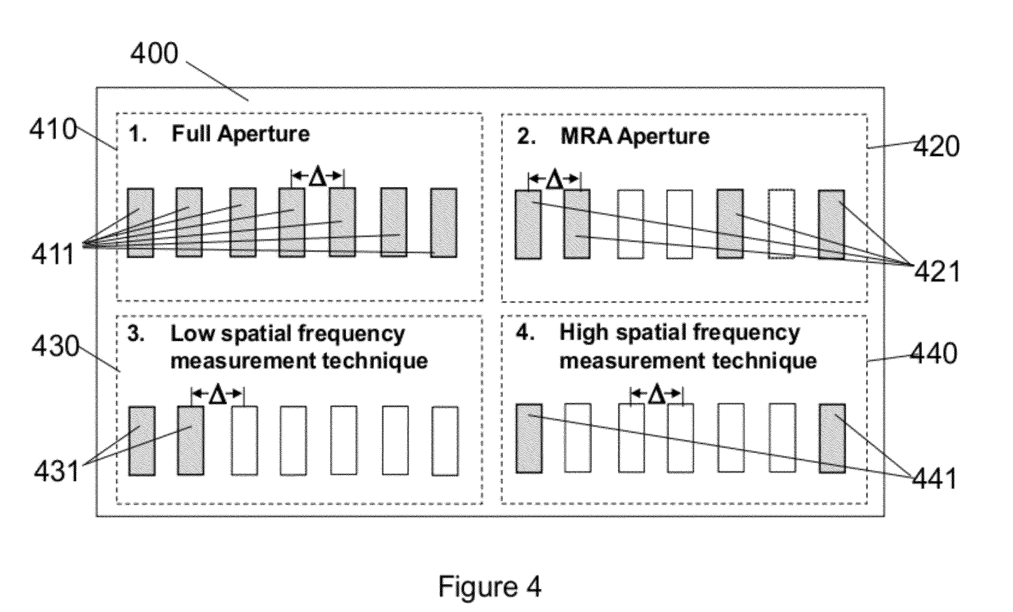

FIG. 4 (400) illustrates 4 linear array geometries; (1) a 7 element full array (411), (2) a minimum redundancy array (MRA) (421); the 4 element MRA (421) with same resolution as that of a 7 element full array (411), (3) an interferometer (431) for measuring low spatial frequency component, and (4) an interferometer (441) for measuring high spatial frequency component.

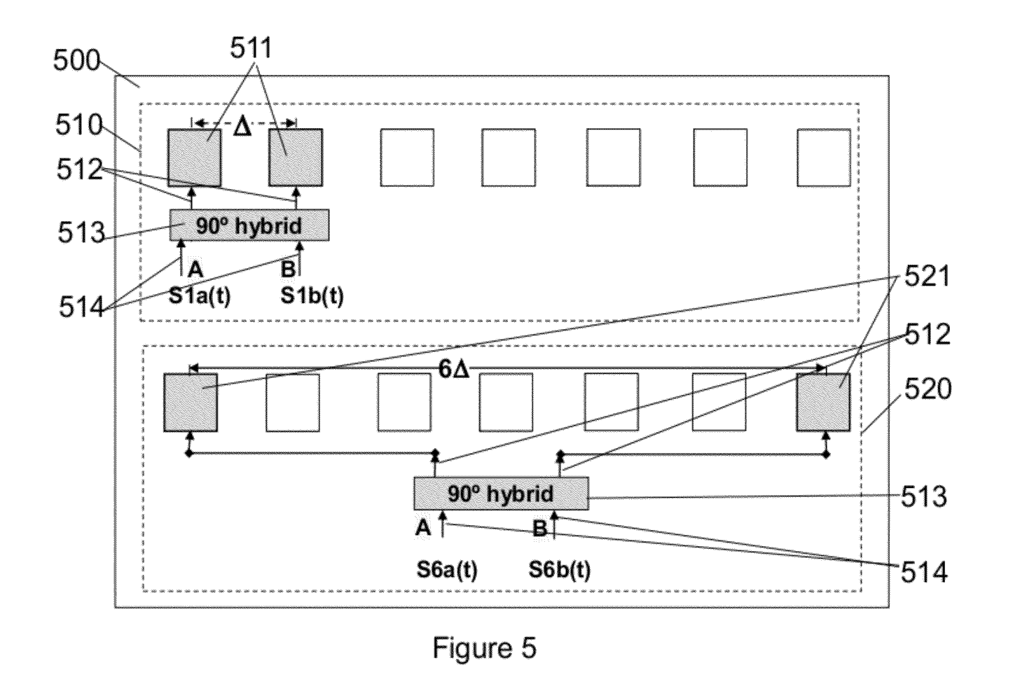

FIG. 5 (500) consists of two panels; panels A (510) and B (520) depicting, interferometer geometries (511, 521) for measuring, respectively, low and high spatial frequency components, by injecting orthogonal waveforms (516, 526). The spacing between the elements (515, 525) in the interferometers (511, 521) dictates the spatial frequency components to be illuminated. The element spacing (515) for low spatial frequency measurement is A, while that spacing (525) for the high spatial frequency is 6Δ. The spatial frequency for the high frequency interferometer (521) is 6 time higher that for the low frequency interferometer (511).

The feed networks for both interferometers are 3-dB hybrids (513, 523), which are 4-poles devices. The signal input ports Δ (514, 524) will result in in-phase split of power at the outputs (512, 522). On the other hand, the signal input ports B (514, 524) will result in quadrature-phase split of power at the outputs (512, 522).

### Low Spatial Frequency Components

A measurement technique features two probing signals to illuminate the I/Q components of a low spatial frequency. The device is a hybrid (513) connected by an interferometer with two radiating elements separated by a “4” distance. Assuming omni directional radiators, the time domain far field distribution of an interferometer from the port “A” excited by S1a(t), is represented by

$$\begin{matrix}g 1 a ( θ , t ) = S 1 a ( t ) + S 1 a ( t ) exp ( - j π / 2 + j 2 π λ / Δ sin ( θ ) ) \\ = S 1 a ( t ) [ ( 1 - sin ( 2 π λ / Δ sin ( θ ) ) + j cos ( 2 π λ / Δ sin ( θ ) ) ]\end{matrix} \qquad ( 5 a )$$

Therefore the field distribution

g1a(θ)=(1−sin(2πλ/Δ sin(θ))+j cos(2πλ/Δ sin(θ)) (5b)

Similarly for port “B” excited by S1b(t),

$$\begin{matrix}g 1 b ( θ , t ) = S 1 b ( t ) + S 1 b ( t ) exp ( j π / 2 + j 2 π λ / Δsin ( θ ) ) \\ = S 1 b ( t ) [ ( 1 + sin ( 2 π λ / Δ sin ( θ ) ) + j cos ( 2 π λ / Δ sin ( θ ) ) ]\end{matrix} \qquad ( 5 c )$$

and

g1b(θ)=(1+sin(2πλ/Δ sin(θ))+j cos(2πλ/Δ sin(θ)) (5d)

Therefore,

sin(2πλ/Δ sin(θ))=(g1b(θ)−g1a(θ))/2, (6a)

and

cos(2πλ/Δ sin(θ))=−j(g1b(θ)+g1a(θ)+2)/2 (6b)

### High Spatial Frequency Components

A technique features two probing signals to illuminate the I/Q components of a high spatial frequency. The device is a hybrid (523) connected by an interferometer with two radiating elements separated by 6A. Assuming omni directional radiators, the time domain far field distributions of an interferometer from the port “A” excited by S6a(t), is represented by

$$\begin{matrix}g 6 a ( θ , t ) = S 6 a ( t ) + S 6 a ( t ) exp ( - j π / 2 + j 2 π 6 λ / Δ sin ( θ ) ) \\ = S 6 a ( t ) [ ( 1 - sin ( 2 π 6 λ / Δ sin ( θ ) ) + j cos ( \frac{2 π 6 λ}{Δ sin ( θ )} ) ]\end{matrix} \qquad ( 7 a )$$

Therefore the field distribution

g6a(θ)=(1−sin(2π6λ/Δ sin(θ))+j cos(2π6λ/Δ sin(θ)) (7b)

Similarly for port “B” excited by S6b(t)

$$\begin{matrix}g 6 b ( θ , t ) = S 6 b ( t ) + S 6 b ( t ) exp ( j π / 2 + j 2 π 6 λ / Δ sin ( θ ) ) \\ = S 1 b ( t ) [ ( 1 + sin ( 2 π 6 λ / Δ sin ( θ ) ) + j cos ( \frac{2 π 6 λ}{Δ sin ( θ )} ) ]\end{matrix} \qquad ( 8 a )$$

and,

g6b(θ)=(1+sin(2π6λ/Δ sin(θ))+j cos(2π6λ/Δ sin(θ)) (8b)

Therefore,

sin(2π6λ/Δ sin(θ))=(g6b(θ)−g6a(θ))/2, (9a)

and

cos(2π6λ/Δ sin(θ))=−j(g6b(θ)+g6a(θ)+2)/2 (9b)

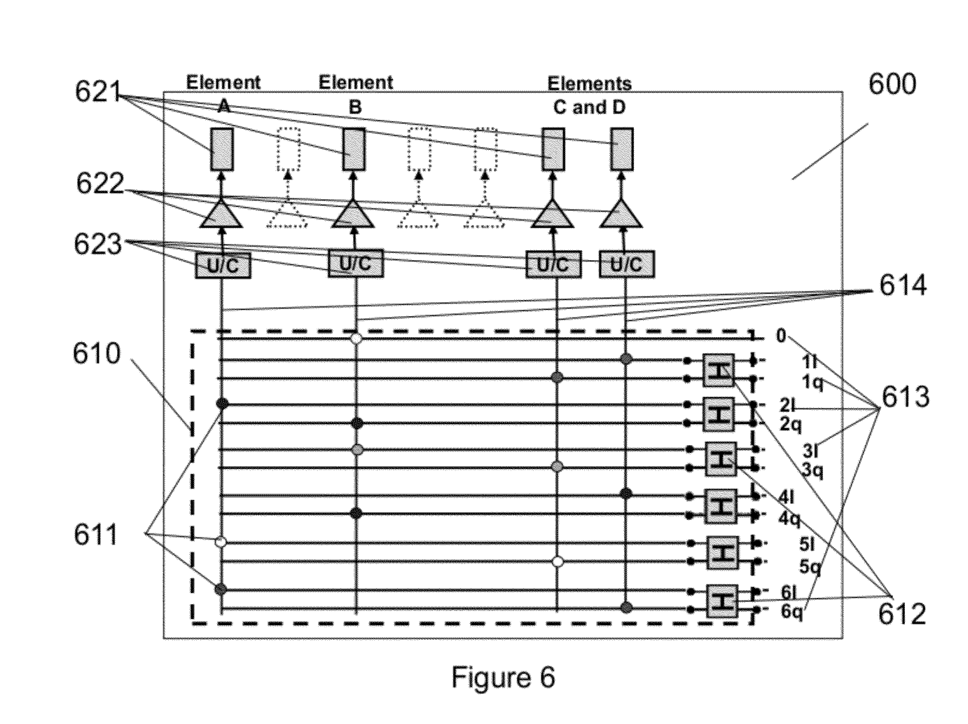

FIG. 6 (600) depicts the MRA geometry (621) for measuring all 7 spatial frequency components, by injecting orthogonal waveforms (613). A waveform injection network (610) organizes 13 orthogonal waveform inputs (613), replicating, grouping, and connecting them into 4 output ports (614). The output signals are frequency up-converted by up-converters (U/C) (623) and then power-amplified by High power amplifiers (HPA) (622) before injected by the radiating MRA elements (621).

To measure various spatial frequency components, 6 interferometers with different baselines (Δ, 2Δ, 3Δ, 4Δ, 5Δ, 6Δ) are constructed by the four element MRA.

There are six 3-dB hybrids (612) associated with the six interferometers. Each functions as a four port device, same as the ones (513, 523) depicted in FIG. 5, with two orthogonal input waveforms indexing the I-components and Q-components of individual spatial frequency components.

The spacing among the elements (621) in these interferometers dictates the spatial frequency components to be illuminated. There are six pairs; Elements (A, B), Elements (A, C), Elements (A, D), Elements (B, C), Elements (B, D), and Elements (C, D). The spacing between elements C and D for lowest spatial frequency measurement is A, while that spacing between elements A and D for the highest spatial frequency is 6Δ. The spatial frequency for the high frequency interferometer constructed by the elements A and D is 6 times higher that of the low frequency interferometer constructed by the elements C and D. Similarly, the spatial frequency for the interferometer constructed by the elements B and D is 4 times higher than that of the low frequency interferometer constructed by the elements C and D.

In addition, there are 4 individual interferometers with “zero” baseline available for measuring spatial dc component from the MRA (621). The 4 pairs are among Elements (A, A), Elements (B, B), Elements (C, C), and Elements (D, D). We have select element B to perform the dc component measurements.

The 13 selected waveforms (613) will be orthogonal to one another (in time and/or frequency domains), and are grouped into 7 groups; 6 pairs and 1 by itself. The 6 interferometer pairs are [(1l, 1q), (2l, 2q), (3l, 3q), (4l, 4q), (5l, 5q), (6l, 6q)]. Their illumination patterns over a field of view covering (−30°, 30°) are depicted in FIGS. 2a, and 2b. The one with linear phase biases are in FIGS. 3a and 3b. The remaining one, indicated as “0”, is intended for indexing dc component measurements of radar returns from a field of view (FOV). The waveform is to index the radar return from uniform illumination on to the entire FOV.

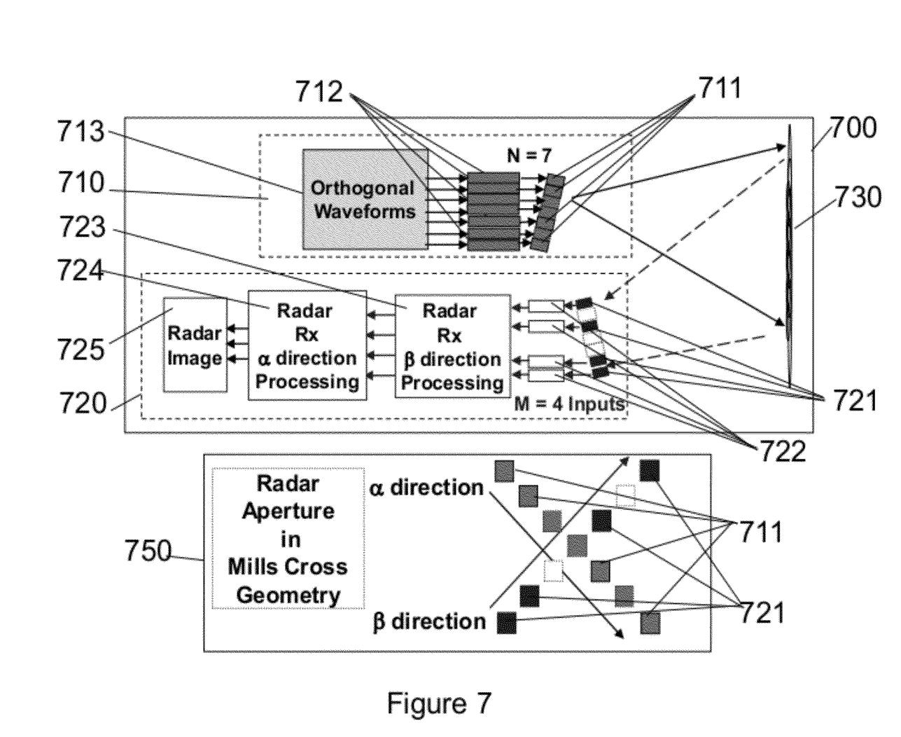

FIG. 7 depicts an example of line-of-sight (LOS) Radar implementation (700) and its Tx and Rx antenna geometries (750). A 7-element Tx linear array (711) is aligned in an α-direction. The Tx array is a “full aperture” array with uniform spacing among adjacent elements, while the Rx array (721) is a MRA with 4 elements aligned in the p-direction, which is physically perpendicular to the α-direction in a Mills Cross [1] geometry.

In the radar transmitter (710), the full aperture Tx linear array (711) will be excited by 7 orthogonal waveforms (713), which are individually frequency up-converted, filtered and power amplified by the 7 assemblies of up-converters and high power amplifiers (712) at operational frequencies, which may be L-band, C-band, Ka band and others.

In the Radar receiver (720), the MRA Rx array (721) features 4 Rx elements which may be co-located with the Tx elements. Each Rx element will capture all radar returns from the FOV of interest, illuminated by the 7 orthogonal waveforms injected by the 7 Tx array elements. The Radar returns will be conditioned by blocks of low noise amplifier and frequency down converters (722) and then undergone through two separated “spatial processors” (723, 724), mainly for the p-direction and the α-direction beam forming respectively to “gain” sufficient SNR with adequate dynamic ranges. The conventional range gating and Doppler processing can be implemented in a radar imaging processor (725) either after the spatial processors or in between the two spatial processing (not shown).

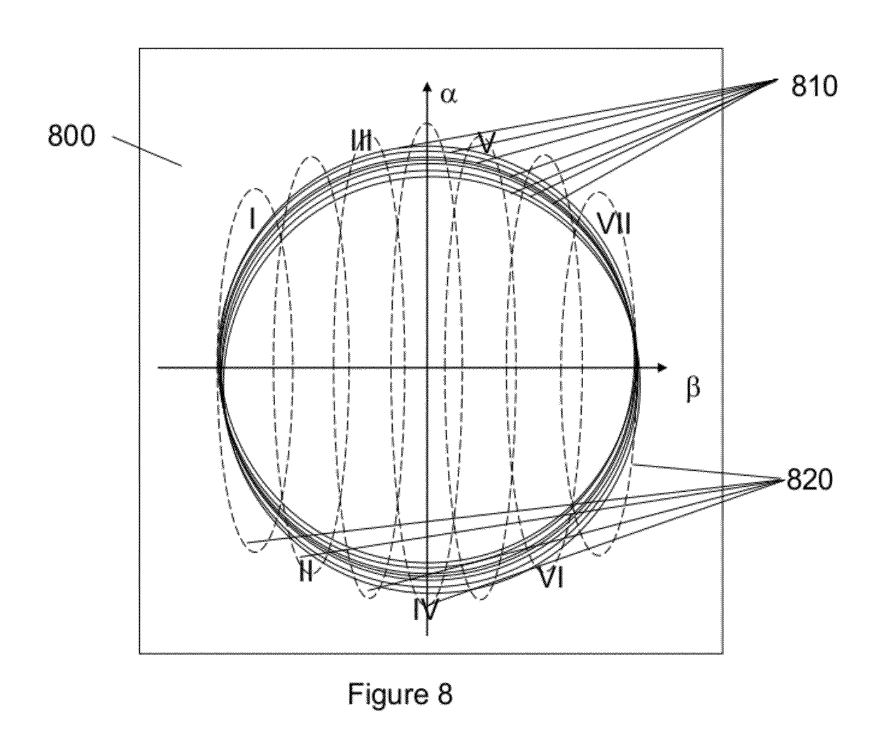

FIG. 8 (800) depicts (1) Tx far field radiation patterns (810) from the Tx full aperture array elements (711), and synthesized Rx far field radiation patterns (820) from the Rx MRA after the p-direction processing (723). The synthesized Rx beam forming processing as presented in FIGS. 2 and 3 consists of spatial frequency component measurement through interferometer pairs.

In FIG. 8;
Tx controlling α-direction resolution (810)
   Element-by-element transmission of individual orthogonal waveforms [a, b, c, d, e, f, g]
   Each illuminate the entire field of view
   Beam forming processing for Tx signals will be carried out on various radar return signals which are indexed by individual waveforms
Rx for p-direction resolution [I, II, III, IV, V, VI]
   Forming multiple real Rx orthogonal beams (820) [I, II, III, IV, V, VI, VII]
Post processing on individual Rx beam, say beam III; enhancing resolution in a-direction
   There are seven radar return data sets indexed by MIMO waveforms [a, b, c, d, e, f, g] individually
   “Coherently” adding the seven data sets synthesizing a Tx beam; there shall be seven Tx orthogonal beams within each Rx beam footprint.

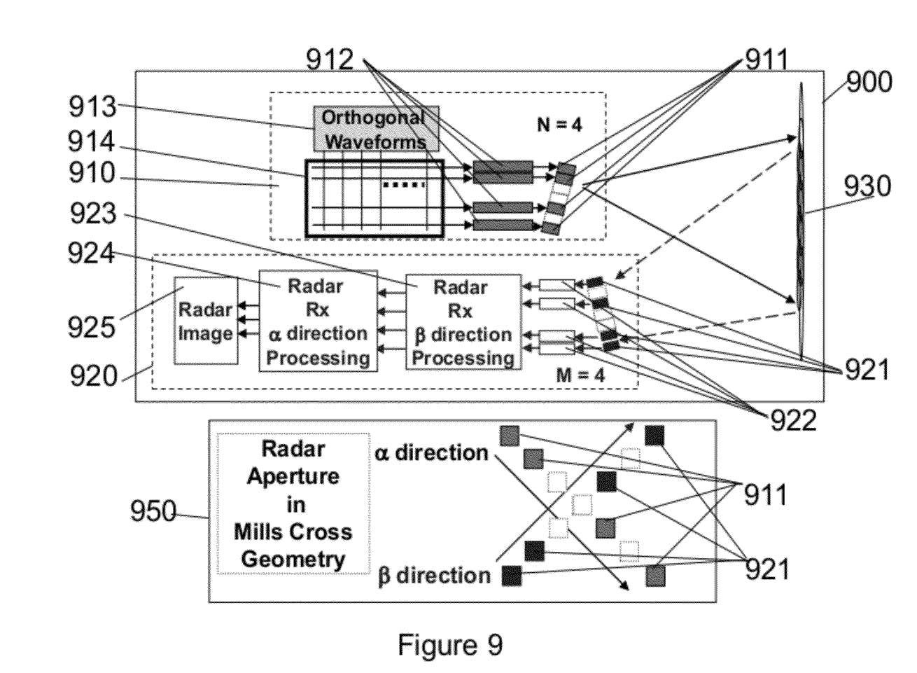

FIG. 9 depicts another example of line-of-sight (LOS) Radar implementation (900) and its Tx and Rx antenna geometries (950). A Tx linear array (911) is aligned in an α-direction. Both Tx and Rx arrays are 4-element MRA arrays with various spacing among adjacent elements. The Rx array elements (921) are aligned in the β-direction, which is physically perpendicular to the α-direction in a Mills Cross [1] geometry.

In the radar transmitter (910), the MRA Tx linear array (711) will be excited by 13 orthogonal waveforms (913), which are organized into 4 output groups by a waveform injection network (914) which is similar to the one (610). Each output is then individually frequency up-converted, filtered and power amplified by the 4 assemblies of up-converters and high power amplifiers (912) at operational frequencies, which may be L-band, C-band, Ka band and others.

In the Radar receiver (920), the MRA Rx array (921) features 4 Rx elements which may be co-located with the Tx elements. Each Rx element will capture all radar returns from the FOV of interest, illuminated by the 13 orthogonal waveforms injected by the 4 Tx array elements. The Radar returns will be conditioned by blocks of low noise amplifier and frequency down converters (922) and then undergone through two separated “spatial processors” (923, 924), mainly for the β-direction and the α-direction beam forming respectively to “gain” sufficient SNR with adequate dynamic ranges. The conventional range gating and Doppler processing can be implemented in a radar imaging processor (925) either after the spatial processors or in between the two spatial processing (not shown).

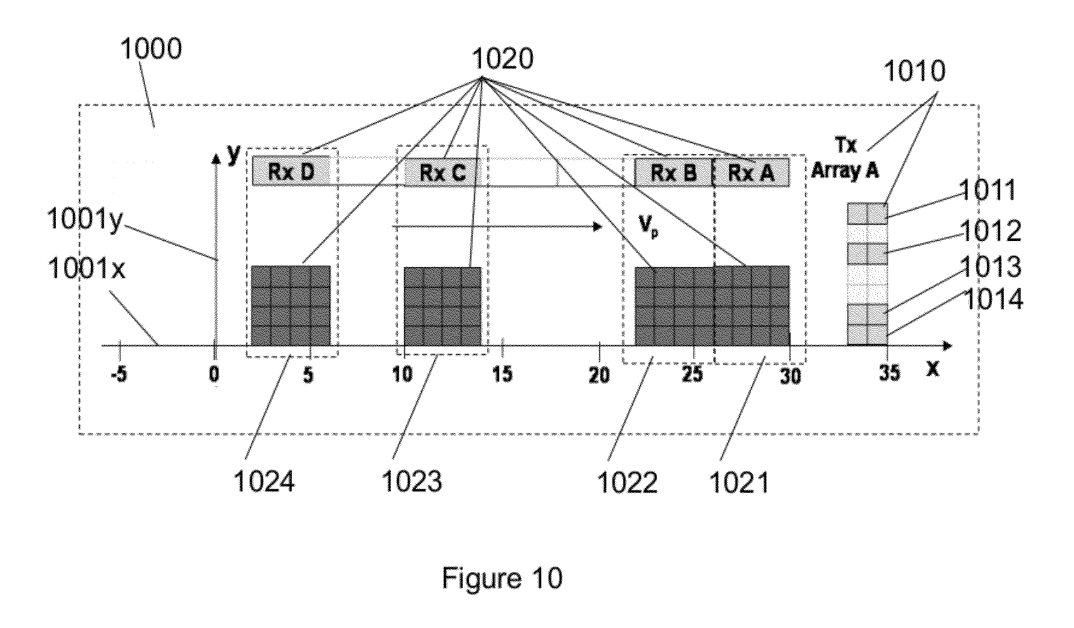

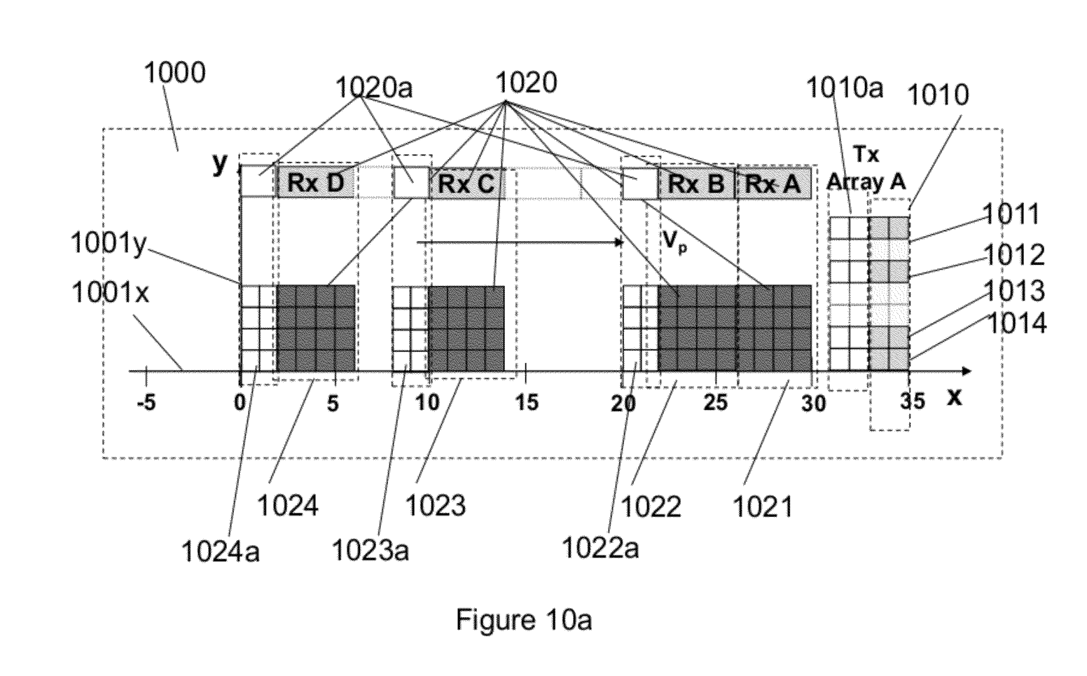

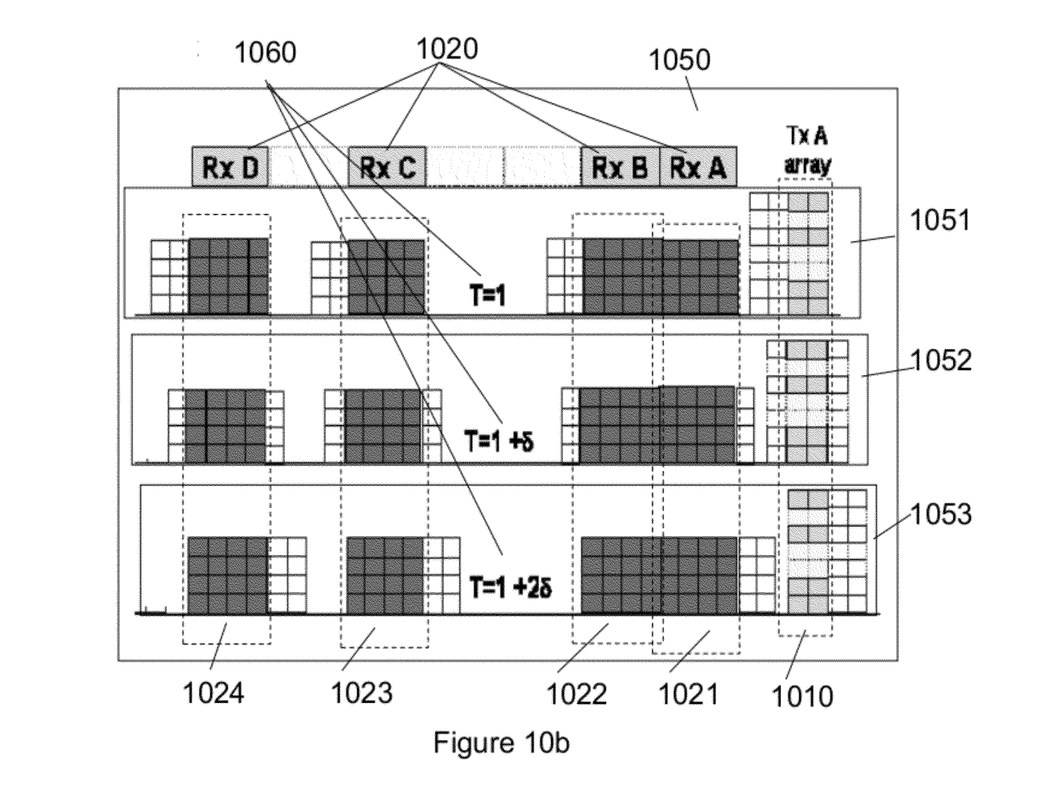

FIG. 10 depicts a third example of line-of-sight (LOS) Radar implementation (1000) on a moving platform moving with a constant velocity Vp (1030) relative to an imaging target. It is a functional geometry of the proposed radar on a moving platform, as an example, consisting of one Tx MRA array, and one Rx MRA array. The spacing among the elements in both the “x axis” and the “y-axis” are in λ/2, where λ is the wavelength. The x-axis shall be the along track direction of the mobile platform.

The Rx array is about 15 wavelengths in the x-direction, and the Tx array 2 wavelength long in the y-direction. At 3 GHz, the total length for the “antenna farm” in the x-direction will be 1.75 meters. As a result, measurements of the 2-D spatial frequency components, or a 2-D spatial spectrum, of a radar image become viable.

### Tx Array; a Minimum Redundancy Array

The proposed Tx array (1010) is a 4 element minimum redundancy array (MRA) aligned in cross-track direction, the y-direction (1001y), and shall be mounted near the front of an air platform. In a basic geometry, it is designed to form six interferometer pairs concurrently. There are only 8 elements grouped into 4 subarrays (1011, 1012, 1013, 1014); mounted on a plane. The two-element Tx subarrays are λ*λ/2, and their long dimension are in the along-track direction, the x-direction (1001x). As a result, these Tx subarrays feature an instantaneous FOV of 60° by 120°; with 60° in the along-track direction and 120° in the cross-track direction. The 4 Tx subarrays are positioned as a MRA in the cross track direction. The corresponding full array would consist of 7 such subarrays. The MRA is the result of subarray thinning, eliminating 3 subarrays out of 7, without losing imaging “resolution” capability. It is a more than 40% thinning process.

The 4 Tx subarrays are located at y=0.5, 1.5, 4.5, and 6.5 units away from the origin, and a unit equals to 0.52. Hence, subarray spacing in y axis is ˜0.5 wavelength, and the FOV ˜120°. The Tx MRA feature a cross-track direction resolution of ˜18° near nadir. The Tx MRA is designed to illuminate 7 spatial frequency components (6 with I/Q and one with real only) within the FOV of the Tx antenna. The “one with real only” is for “dc” spatial frequency illumination. The Tx MRA elements, the 4 Tx subarrays, can be organized to form 6 pairs of interferometers; each radiated a pair of the probing waveforms. Therefore, there will be 12 waveforms for 6 interferometers and one additional for the dc component. These 13 probing waveforms are “orthogonal” to one another.

### Rx Antenna; MRA Geometry

Functionally, the Rx MRA (1020) consists of 16 4-element subarrays grouped into 4 building blocks (1021, 1022, 1023, 1024). The building blocks are arranged into a 4-element MRA geometry, Rx A, Rx B, Rx C, and Rx D, in the along track direction as shown. Each building block consists of 16 elements grouped into 4-subarrays.

Each Rx subarray consists of four 0.5 λ squared elements which are aligned in the cross-track direction, the y-direction. Beam forming mechanisms for each of the subarrays will produce one fixed fan beam pointed at 10° off from the boresite with a 30° beamwidth in the cross track direction, and 120° in the along track direction. The peak gain for an Rx subarray is ˜10 dB.

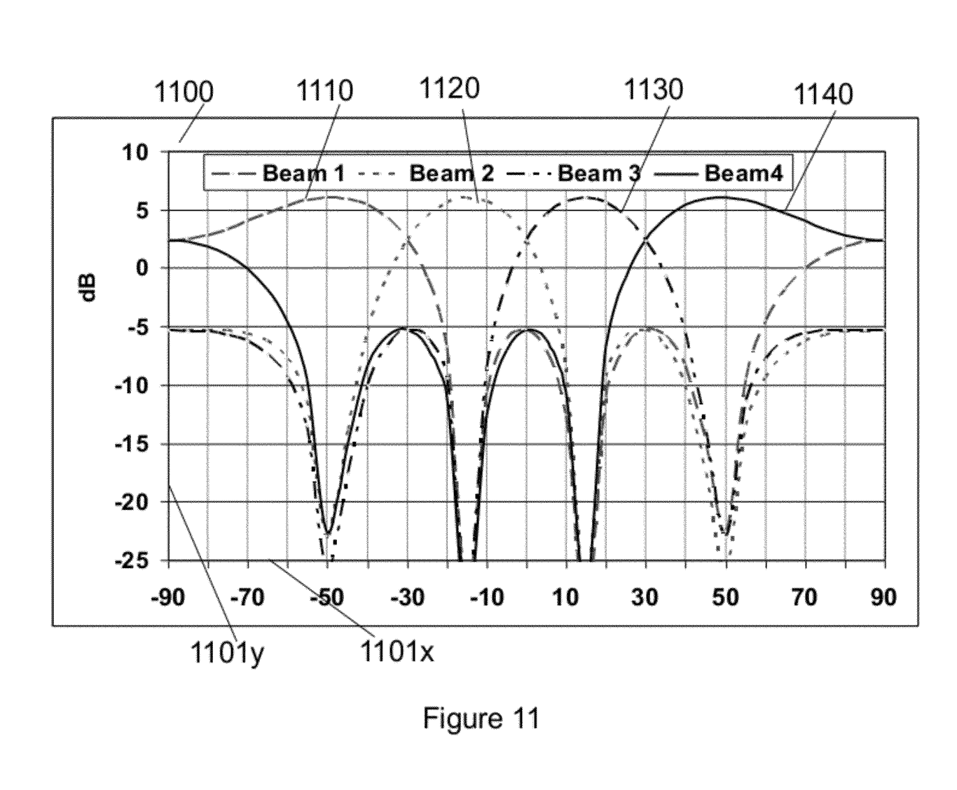

There are 4 concurrent orthogonal beams in the along-track direction formed by a digital processor functioning as Butler matrix for each building block as depicted in FIG. 11. Only the array factor contributions are illustrated. The four beams peaked at −48°, −14°, 14°, and 48°, respectively, are referred to as Beam_{—}1, Beam_{—}2, Beam_{—}3, and Beam_{—}4. Since 4 Rx subarrays are the elements for the full array, the total gain for a building block shall be about 16 dB taking into account of the 10 dB subarray gain.

Only two of the 4 beams, Beam_{—}2 and Beam_{—}3, are used in our baseline design. Each of the Rx building blocks generates 2 circular beams with a 30° beamwidth cascaded in the along track direction.

The Rx MRA geometry is indicated by locations of the 4 building blocks; Rx A, Rx B, Rx C, and Rx D in FIG. 10. Each of them is 2λ wide, and features a full array consisting of 4 Rx subarrays aligned in the along track direction. The spacing between the centers of the 4 adjacent building blocks is 1*2λ, 3*2λ, and 2*2λ, respectively. The geometry design supports both polarizations; either linearly polarized (both HP and VP) signals, or circularly polarized (both LHCP and RHCP) signals.

Both Tx and Rx arrays are 4-element MRA arrays with various spacing among adjacent elements while Rx array antenna geometry (1020) is aligned accordingly in the along-track direction, the x-direction (1001x). Similarly there are 4 Rx array elements (1020); each is a 16 element subarray. The 4 subarrays, Rx A (1021), Rx B (1022), Rx C (1023), and Rx D (1024), are spaced as a MRA. However, the spacing units in the x-direction, the along-track direction, are 4-times larger than those in the y-direction in this example. The Tx and Rx arrays are physically perpendicular to one another similar to ones in Mills Cross [1] geometries.

In the radar transmitter (not shown), the MRA Tx linear array (1010) will be excited by 13 orthogonal waveforms (913), which are organized into 4 output groups by a waveform injection network (914) which is similar to the one (610). Each output is then individually frequency up-converted, filtered and power amplified by the 4 assemblies of up-converters and high power amplifiers (912) at operational frequencies, which may be L-band, C-band, Ka band and others.

In the Radar receiver (not shown), the MRA Rx array (1020) features 4 Rx elements which may be co-located with the Tx elements. Each Rx element will capture all radar returns from the FOV of interest, illuminated by the 13 orthogonal waveforms injected by the 4 Tx array elements.

The Radar returns will be conditioned by blocks of low noise amplifier and frequency down converters (922) and then undergone through two separated “spatial processors” (923, 924), mainly for the along-track direction and the cross-track direction beam forming respectively. The beam forming processing will perform both subarray beam forming and the MRA beam forming processing to “gain” sufficient SNR with adequate dynamic ranges at both along track and cross track directions.

In the cross-track directions, virtual transmit beams are dynamically constructed based on the waveform indexed radar returns in the post processing (924) to virtually focus Radar Tx illumination power to a selected “strip” of interest. The illuminations can also be effectively “shaped” in the cross track direction by processing the received radar return signals indexed by the orthogonal waveforms for the illuminated spatial spectrum over the selected FOV.

At the along-track directions, the subarrays (1020) can be configured to form spot beams, shaped beams, and/or multiple beams concurrently.

The conventional range gating and Doppler processing can be implemented in a radar imaging processor (925) either after the spatial processors or in between the two spatial processing (not shown).

FIG. 10a illustrates a modified version of the proposed radar configurations. It will enable the functions of ground moving target indication (GMTI). Contrast to the one shown in FIG. 10, the transmit array (1010 and 1010a) features four subarrays but each with 4 elements instead of two. However, only two adjacent elements of the four subarrays will be active at a given time as shown in FIG. 10b. As the platform moves with a constant velocity, the Tx aperture is configurable to support three time slots (1060) where the active portions of the Tx aperture will appear at the same locations in space with respect to all stationary targets on ground.

Six subarrays (1020a) are divided into threes separated groups (1024a, 1023a, and 1022a) and added to the Rx array building blocks individually. Equivalently, each of the 4 building blocks (1020) will feature 6 selectable subarrays in the along-track direction. Only four adjacent subarrays for a building block will be active at a given time as shown in FIG. 10b. As the platform moves with a constant velocity along x-direction, the Rx aperture is configurable to support three time slots (1060) where the active portions of the Rx aperture (1021, 1022, 1023, 1024) will appear at the same locations in space with respect to all stationary targets on ground.

Rx A (1021) building block will utilize the right most two subarrays of Rx B (1022) building block as the additional subarrays. In fact, there will always be 8 adjacent subarrays for the combined building block of Rx A plus Rx B (1021 plus 1022). To accommodate the goals of three time slots (1060) with the identical active aperture geometry (1051, 1052, 1053), only two additional subarrays (1022a) are added to the extension of the combined building block of Rx A plus Rx B (1021 plus 1022).

### Tx MIMO Waveforms:

For the preliminary designs, the proposed waveform transmission schemes for the MRA are illustrated functionally in FIG. 6 (600). The terms “HPAs” and “U/Cs” (623) stand for high power amplifiers, and frequency up-converters respectively.

Orthogonal waveforms are used to “indexing” the radiation patterns of the Tx spatial frequency components over the FOV, which is 120° in cross track direction and 60° in along-track direction. Radar returns over the FOV from all these spatial frequency components are used to focus radiated power to various strip of the FOV in a receive processor. These radar returns are indexed by the waveforms. The resolution of the 4 Tx subarray MRA, the same as a full array using 7 subarrays, is about 18° near boresite. On the other hand, it also provides nulling capability with a resolution in the order of 2° near boresite for the cross track direction.

The far field radiation (voltage) pattern for the corresponding full array with 7 subarray elements can be written as

$$\begin{matrix}ff ( θ ) = Σ {Wn}^{*} exp [ j ( 2 π / λ ) Δ dy n sin ( θ ) ] \\ = Σ {Wn}^{*} exp [ j π n sin ( θ ) ] ,\end{matrix} \qquad \begin{matrix}( 10 ) \\ ( 10 a )\end{matrix}$$

where n=1 to 7, and Wn represents the nth element weighting due to both aperture taper and phase progression for beam steering. The adjacent element spacing, Δdy, for the full array is 0.5×. Equation (1a) can be re-written in a (U V) coordinate where u=sin(θ) as

ff(u)=ΣWn8exp[jπnu] (11)

There are 7 spatial frequency components in “u” in the far field illumination (radiation) pattern. The spatial dc component is when n=0, and its far-field voltage amplitude equals to W0. The radiated intensity, or power, for the dc component is (W0)̂2. Similarly, the spatial spectrum for the first component is the components associated with n=1, and so on.

There are 7 those components in cross-track direction; 6 with 1/Q and 1 real only. Therefore we need 13 “independent” waveforms. On the other hand when transmitted concurrently, these waveforms shall be asynchronously orthogonal among one another. We need both I and Q components for each spatial frequency component, to provide the flexibility of altering “spatial phase” in Radar receive processing.

The proposed Tx MRA (1010) can emulate a full array, since its geometry consists of various baselines to account for all spatial frequency components of the full array. It shall enable the receive processing to form any shape of virtual illumination beams over the selected FOV, just like any real beams from the corresponding full array.

Since beam forming and RF wave propagations including reflections are linear process, the laws of superposition and commutation are applicable. Therefore in radar receiving processing, it becomes possible to take advantage of these indexed radar returns, “re-focusing” the indexed illuminations to behave as a dynamic virtual Tx fan beam centered at, say, either 25° or 10° to the right from flying paths. These indexed radar returns shall enable simultaneously processing of multiple strips of images.

On the right of FIG. 6, there are 13 input ports (613) for various Radar waveforms; namely, 0, (1l, 1q), (2l, 2q), (3l, 3q), (4l, 4q), (5l, 5q), and (6l, 6q). Waveform on Port 0 will be transmitted by subarray B. The hybrid functions are identical to that of a 3-dB 90° coupler. The two outputs of the hybrid fed by 1I and 1Q ports with S1l and S1q waveforms will be inputted to subarrays D and C. The resulting waveforms are represented by Sd1 and Sd2 respectively.

Sd1=0.707*(S1l+j S1q) (12a)

Sc1=0.707*(S1l−j S1q) (12b)

Subarrays C and D are separated in across track direction (or y-axis) by a Δdy, or 0.5 λ. The illuminated spatial frequency component is one unit in “u” domain. The spatial frequency components for the MRA features “0.5” cycle per 1 u-unit. The sinusoid component corresponds to half a cycle variation from u=0 (θ)=θ° to u=1 (θ)=90°.

Similarly, the two outputs of the hybrid fed by 2I and 2Q ports with S2I and S2q waveforms will be inputted to subarrays A and B. The resulting waveforms are represented by Sd1 and Sd2 respectively.

Sb1=0.707*(S2l+j S2q) (13a)

Sa1=0.707*(S2l−j S2q) (13b)

Subarrays A and B are separated in across track direction (or in y-axis) by 2 Δdy, or a λ.

Tx waveform schemes are summarized as follows:
a. total 13 independent Tx waveforms (613) for the MRA (1010)
   1. 12 of them are for 6 interferometer pairs with various baselines; corresponding to 6 spatial frequency components of the MRA(1010).
   2. Plus one additional “I” waveform; representing spatial dc component.
b. Each pair fed by a digitally implemented Beam-Forming Network (BFN), or DBF, with two-inputs-and-two-outputs; DBFs function as 90° hybrids (612).
c. As a results of the simple DBF, radiated intensity over the FOV for each waveform features a spatial distribution of
   1. a sinusoidal with a unique spatial frequency over 120° in cross track direction, and
   2. uniform over 30° in along-track direction.

There are only 4 subarray elements (1011, 1012, 1013, 1014) in the Tx MRA (1010) but we will have total 13 orthogonal waveforms (613) transmitted concurrently. Except subarray B (1012), each subarray element transmits 6 waveforms concurrently. Subarray B (1017) transmits 7 orthogonal waveforms simultaneously.

### Rx Processing Architecture

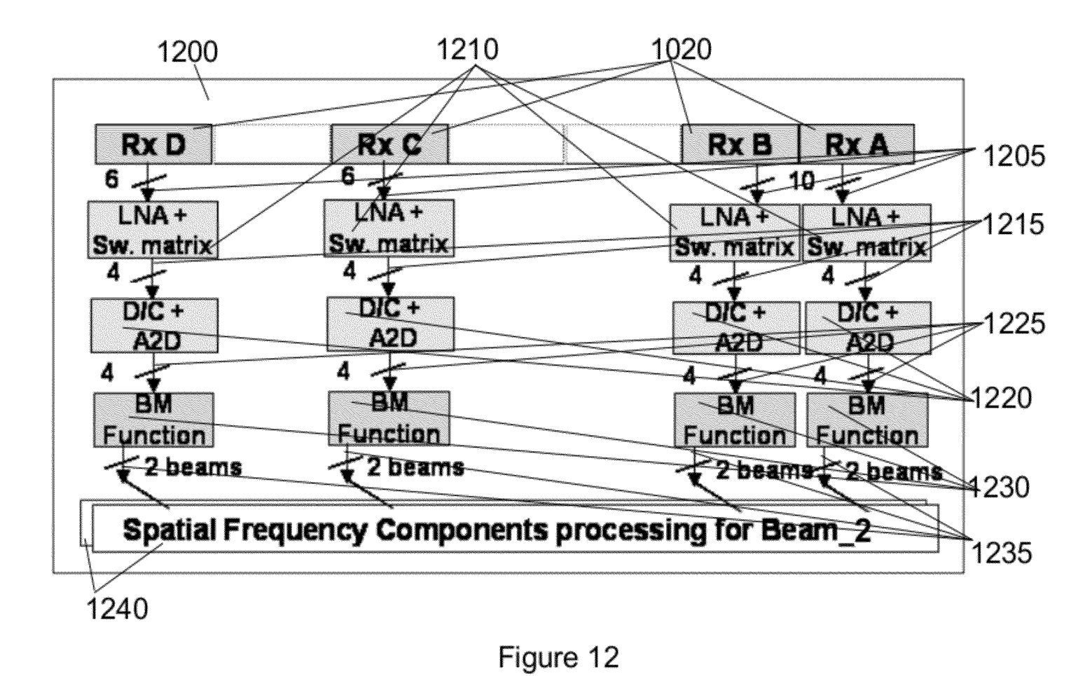

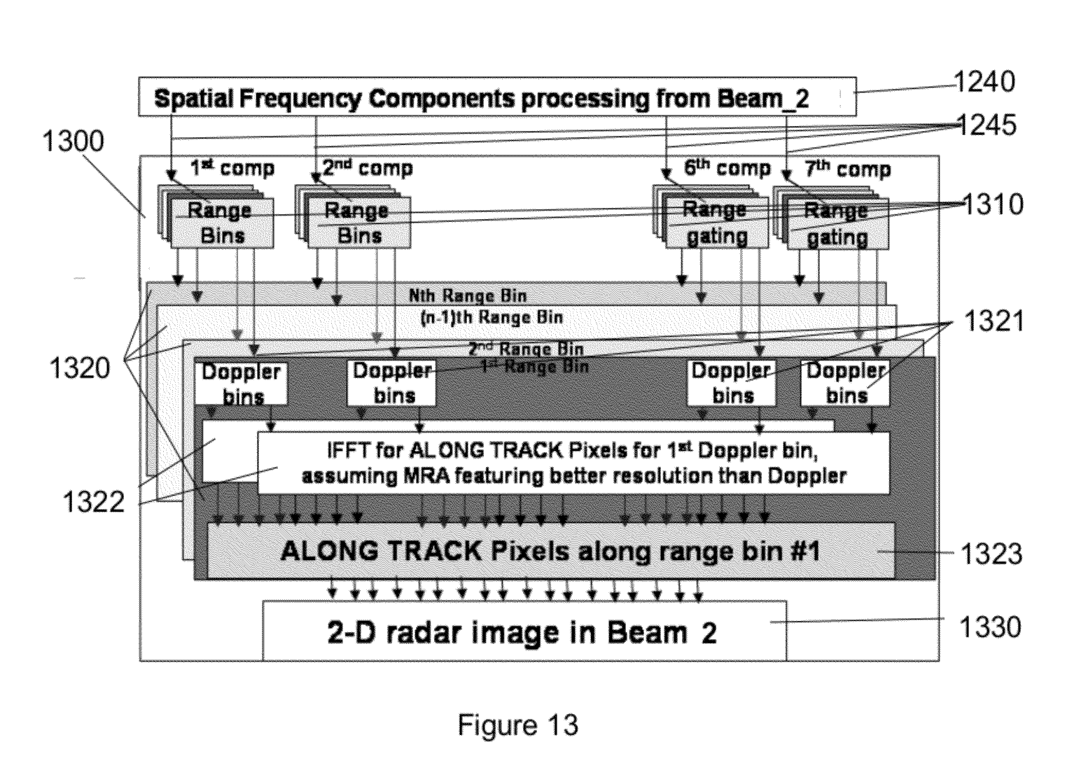

Rx processing is depicted in FIGS. 12 (1200) and 13 (1300). In FIG. 12 (1200), each Rx building block (1020) with 6 subarrays (1205) will be followed by 6 LNAs and a 6-to-4 switching matrix (1210). Four outputs (1215) are frequency down converted before digitized by 4 parallel A-D's (1220). In digital domain, a beam forming processing, similar to the Butler matrix (BM) functions (1230), generates four concurrent orthogonal beams in the along track direction for each of the building block. We only pick two middle ones (1235) from the four for further Rx processing.

Furthermore, all four building blocks will produce the same foot prints for the two beams in the far field (1240). These footprints are referred as Beam_{—}2 and Beam_{—}3. Therefore the radar returns from each of the two footprints are collected by 4 separated building blocks (1024); Rx A, Rx B, Rx C, and Rx D simultaneously.

Among the building blocks in the RX MRA, we take advantage of beam space; processing the radar return in the spatial spectrum domain separately from the two contiguous footprints Beam_{—}2 and Beam_{—}3. For each footprint, 7 spatial frequency components in the along track direction are measured using interferometer processing.

As shown in FIG. 13, conventional Radar processing for each Rx spatial frequency component, will be used to separate radar return according to Range bins (1310) and Doppler bins (1321) which provide cross-track and along-track resolutions

### Radar Image Reconstructions

Within the Rx footprint Beam_{—}2 or Beam_{—}3, there are four sets of discriminates on the Radar return signals. The database after processing has the following structure;
Cross track spatial spectrum; spatial frequency components are indexed by Tx waveforms (7 complex or 13 real spatial frequency components),
   Along-track spatial spectrum for each of the cross track spatial frequency components
      i. for each along-track spatial frequency components multiple range gating are applied to the radar return
         for each range gate, the radar return are “divided” into many Doppler frequency bins.

In principle, we do the following:
combine the Tx spatial spectrum data based on a virtual illumination from a Tx fan beam to gain better resolution in cross track direction;
combine the along track data emulating 7 additional virtual beams within each real “foot print” of both Beam_AT2 and Beam_AT3 via along track spatial spectrum;
using cross-product of a Tx virtual beam and Rx virtual beams;
within each cross apply conventional range and Doppler gating for final imaging resolutions.

### Moving Target Indication Processing

The technique of moving target detection is important for surveillance, traffic monitoring, and other applications. In last few years, more attentions are focused on distributed aperture SAR systems[8, 9, 10]. Both the Along-Track Interferometry (ATI) and Displaced Phase Center Antenna (DPCA) techniques can estimate the position and radial velocity of a moving target; however they are used in different situation.

Both post-processing techniques will work with the proposed MIMO radar architectures on moving platforms as depicted in FIGS. 10a and 10b.

What is claimed is:

1. A radar imaging system comprising:
a transmit antenna divided into a plurality of array segments adapted to transmit a plurality of orthogonal radar waveforms to illuminate a target region extending in a range direction and in an azimuth direction;
a waveform generator capable of generating the plurality (N) of orthogonal waveforms concurrently for radar illuminations whereas N is a positive integer;
a receive antenna divided into a plurality of array segments, wherein the receive antenna is adapted to receive a radar return from the target region and to generate a plurality of return signals associated with corresponding ones of the plurality of array segments;
a post processing performing three functions on Radar return signals; (1) synthesizing receiving beams, (2) generating virtual transmit beams, and (3) performing convention radar ranging and Doppler processing.

2. The radar imaging system of claim 1, wherein the plurality (M) of array segments of the transmit antenna comprise a linear array whereby ones of the plurality (M) of array segments are positioned along a straight line whereas M is an integer greater than 1.

3. The radar imaging system of claim 1, wherein the plurality (N) of orthogonal waveforms are generated and the plurality (M) of linear combinations of the N orthogonal waveforms are grouped, amplified, and radiated by individual transmit array segments.

4. The radar imaging system of claim 1, wherein the plurality of array segments of the receive antenna comprise a sparse linear array whereby ones of the plurality of array segments are positioned along a straight line such that spacing between pairs of the plurality of range segments are irregular.

5. The radar imaging system of claim 4, wherein the sparse linear array is further adapted to comprise a minimally redundant array whereby a number of pairs of array segments having equal spacing is minimized.

6. The radar imaging system of claim 1, wherein the at least one post processor further performs receiving beam forming functions comprising a weighting unit adapted to apply a plurality of complex weighting factors to corresponding ones of the plurality of spatial-frequency signals of the receiving sparse array.

7. The radar imaging system of claim 1, wherein one post processor further performs virtual transmitting beam forming functions comprising a weighting unit adapted to apply a plurality of complex weighting factors to corresponding radar returns from the plurality (N) of illuminating orthogonal signals from the plurality (N) of array segments of the transmitting linear array.

8. The radar imaging system of claim 1, wherein the range and Doppler processor adapted to further signal process and divide the plurality of return signals into the plurality of range and Doppler slices after the receiving and virtual transmitting beam-forming processors.

9. A radar imaging system comprising:
a transmit antenna divided into a plurality of array segments adapted to transmit a plurality of orthogonal radar waveforms to illuminate a target region extending in a range direction and in an azimuth direction;
a waveform generator capable of generating the plurality (N) of orthogonal waveforms concurrently for radar illuminations whereas N is a positive integer;
a receive antenna divided into a plurality of array segments, wherein the receive antenna is adapted to receive a radar return from the target region and to generate a plurality of return signals associated with corresponding ones of the plurality of array segments;
a post processing performing three functions on Radar return signals; (1) synthesizing receiving beams, (2) generating virtual transmit beams, and (3) performing convention radar ranging and Doppler processing.

10. The radar imaging system of claim 9, wherein the plurality (M) of array segments of the transmit antenna comprise a linear array whereby the plurality (M) of array elements are positioned along a straight line and M is an integer greater than 1.

11. The radar imaging system of claim 9, wherein the plurality of orthogonal waveforms are generated, amplified, and radiated by individual transmit array elements concurrently.

12. The radar imaging system of claim 9, wherein the plurality of array segments of the receive antenna comprise a sparse linear array whereby ones of the plurality of array segments are positioned along a straight line such that spacing between pairs of the plurality of range segments are irregular.

13. The radar imaging system of claim 12, wherein the receiving sparse linear array is further adapted to comprise a minimally redundant array whereby a number of pairs of array segments having equal spacing is minimized.

14. The radar imaging system of claim 9, wherein the at least one post processor further perform receiving beam forming functions comprising a weighting unit adapted to apply a plurality of complex weighting factors to corresponding ones of the plurality of spatial-frequency signals of the receiving sparse array.

15. The radar imaging system of claim 9, wherein one post processor further perform virtual transmitting beam forming functions comprising a weighting unit adapted to apply a plurality of complex weighting factors to the radar returns from an area of interest illuminated by the plurality (N) of orthogonal waveforms from the plurality (N) of the transmitting linear array elements.

16. The radar imaging system of claim 9, wherein the range and Doppler processor adapted to further signal-process and divide the plurality of return signals into the plurality of range and Doppler slices after the receiving and virtual transmitting beam-forming process.

17. A radar imaging system comprising:
a transmit antenna divided into a plurality of array segments adapted to transmit a plurality of orthogonal radar waveforms to illuminate a target region extending in a range direction and in an azimuth direction;
a waveform generator capable of generating the plurality (N) of orthogonal waveforms concurrently for radar illuminations whereas N is a positive integer;
a receive antenna divided into a plurality of array segments, wherein the receive antenna is adapted to receive a radar return from the target region and to generate a plurality of return signals associated with corresponding ones of the plurality of array segments;
a post processing performing three functions on Radar return signals; (1) synthesizing receiving beams, (2) generating virtual transmit beams, and (3) performing convention radar ranging and Doppler processing.

18. The radar imaging system of claim 17, wherein the plurality (M) of array segments of the transmit antenna comprise a linear array whereby the plurality (M) of array elements are positioned along a straight line such that spacing between pairs of the plurality of range segments are irregular whereas M is an integer greater than 1.

19. The radar imaging system of claim 18, wherein the transmitting sparse linear array is further adapted to comprise a minimally redundant array whereby a number of pairs of array segments having equal spacing is minimized.

20. The radar imaging system of claim 17, wherein the plurality (N) of orthogonal waveforms are generated and the plurality (M) of linear combinations of the N waveforms are grouped by a multiple waveform injection network whereas the M grouped waveforms are amplified and radiated by individual transmit array segments.

21. The radar imaging system of claim 17, wherein the plurality of array segments of the receive antenna comprise a sparse linear array whereby ones of the plurality of array segments are positioned along a straight line such that spacing between pairs of the plurality of segments are irregular.

22. The radar imaging system of claim 17, wherein the receiving sparse linear array is further adapted to comprise a minimally redundant array whereby a number of pairs of array segments having equal spacing is minimized.

23. The radar imaging system of claim 17, wherein the at least one post processor further performs receiving beam forming functions comprising a weighting unit adapted to apply a plurality of complex weighting factors to corresponding ones of the plurality of spatial-frequency signals of the receiving sparse array.

24. The radar imaging system of claim 17, wherein one post processor further performs a virtual transmitting beam forming functions comprising a weighting unit adapted to apply a plurality of complex weighting factors to the radar returns from the plurality (N) of illuminating orthogonal signals from the plurality (M) of the transmitting linear array elements.

25. The radar imaging system of claim 17, wherein the range and Doppler processor adapted to further signal process and divide the plurality of return signals into the plurality of range and Doppler slices after the receiving and virtual transmitting beam-forming process.

26. The waveforms injection network of the radar imaging systems comprising N-to-M passive architectures using two cascading functions of re-distribution and combining whereas the N is the number of input ports connecting to different orthogonal waveforms and M is the number of output ports connecting to various transmitting array segments.

27. The waveforms injection network of claim 26, whereas the re-distribution functions comprise 3 dB hybrid networks featuring:
an input port for unique waveform is connected to two output ports which are connected to two elements of an interferometer;
a pair of input ports are assigned to an interferometer generating I/Q channels;
N inputs and N outputs.

28. The waveforms injection network of claim 26, whereas the combining functions comprise passive combining devices featuring M identical N-to-1 combiners.

29. The waveforms injection network of claim 26, whereas the re-distribution and combining functions comprise digital units performing operations featuring replication, hybrid functions, summing and combining functions.

30. A radar imaging system on a moving platform comprising:
a transmit antenna divided into a plurality of array segments adapted to transmit a plurality of orthogonal radar waveforms to illuminate a target region extending in a range direction and in an azimuth direction;
a waveform generator capable of generating the plurality (N) of orthogonal waveforms concurrently for radar illuminations whereas N is a positive integer;
a receive antenna divided into a plurality of array segments, wherein the receive antenna is adapted to receive a radar return from the target region and to generate a plurality of return signals associated with corresponding ones of the plurality of array segments;
a post processing performing three functions on Radar return signals; (1) synthesizing receiving beams, (2) generating virtual transmit beams, and (3) performing conventional radar ranging and Doppler processing and advanced mobile target indication (MTI) processing.

31. The radar imaging system on a moving platform of claim 30, wherein the plurality (M) of array segments of the transmit antenna comprise a linear array whereby ones of the plurality (M) of array segments are positioned along a straight line whereas M is an integer greater than 1.

32. The radar imaging system of claim 30, wherein the plurality (N) of orthogonal waveforms are generated and the plurality (M) of linear combinations of the N orthogonal waveforms are grouped, amplified, and radiated by individual transmit array segments.

33. The radar imaging system of claim 30, wherein the plurality of array segments of the receive antenna comprise a sparse linear array whereby ones of the plurality of array segments are positioned along a straight line such that spacing between pairs of the plurality of range segments are irregular.

34. The radar imaging system of claim 30, wherein the sparse linear array is further adapted to comprise a minimally redundant array whereby a number of pairs of array segments having equal spacing is minimized.

35. The radar imaging system of claim 30, wherein the at least one post processor further performs receiving beam forming functions comprising a weighting unit adapted to apply a plurality of complex weighting factors to corresponding ones of the plurality of spatial-frequency signals of the receiving sparse array.

36. The radar imaging system of claim 30, wherein one post processor further performs virtual transmitting beam forming functions comprising a weighting unit adapted to apply a plurality of complex weighting factors to corresponding radar returns from the plurality (N) of illuminating orthogonal signals from the plurality (N) of array segments of the transmitting linear array.

37. The radar imaging system of claim 30, wherein the range and Doppler processor adapted to further signal process and divide the plurality of return signals into the plurality of range and Doppler slices after the receiving and virtual transmitting beam-forming processors.

38. The radar imaging system of claim 30, wherein the moving target indication (MTI) processor adapted to further signal process on the processed data at different time slots whereas the processed data are the return signals after the
the receiving beam-forming processor;
and virtual transmitting beam-forming processor; and
range and Doppler processing.
